(19) United States
(12) Patent Application Publication
(10) Pub. No.: US 2021/0235728 A1
(43) Pub. Date: Aug. 5, 2021

(54) SYSTEMS AND METHODS FOR EXTENDING SHELF LIVES OF BOTANICAL AND FOOD PRODUCTS

(71) Applicant: PuroGen Laboratories, LLC, Winter Park, FL (US)

(72) Inventor: Alan J. Novotny, Winter Park, FL (US)

(73) Assignee: PuroGen Laboratories, LLC

(21) Appl. No.: 17/237,993

(22) Filed: Apr. 22, 2021

Related U.S. Application Data
(63) Continuation-in-part of application No. 16/958,474, filed on Jun. 26, 2020.
(60) Provisional application No. 62/612,532, filed on Dec. 31, 2017.

(51) Int. Cl. A23L 3/22; A23L 3/015; A23L 3/02; A23L 3/10

(52) U.S. Cl. CPC A23L 3/22; A23L 3/10; A23L 3/02; A23L 3/0155

(57) ABSTRACT

Systems and methods for processing a product. The methods comprise: receiving the product in a vacuum chamber, the product enclosed within a first packaging item having at least a portion that is semi-permeable under vacuum conditions; introducing a reagent into the vacuum chamber (the reagent comprising a combination of a sterilization substance for sterilizing the product and a preservation substance for preserving a sterilization state of the product); causing the reagent to pass through the portion of the first packaging item that is semi-permeable such that a sterilization of the product by the sterilization substance occurs concurrently with a modification of an internal atmospheric condition within the first packaging item by the preservation substance; and preserving the sterilized state of the product via the modified internal atmospheric condition of the first packaging.

### CROSS REFERENCE TO RELATED APPLICATIONS

This application is a continuation-in-part of U.S. patent Ser. No. 16/958,474 which was filed on Jun. 26, 2020 and claims priority to and benefit of PCT/US2018/068107 which was filed on Dec. 31, 2018 and U.S. Provisional Patent Application No. 62/612,532, filed Dec. 31, 2017. The entire content of these applications are hereby expressly incorporated by reference for all purposes.

### STATEMENT OF THE TECHNICAL FIELD

The present document relates to systems and methods for processing products. More particularly, the present document relates to implementing systems and methods for extending shelf lives of botanical and food products.

### DESCRIPTION OF THE RELATED ART

Sterilants are used in environments (such as hospitals) to render objects (e.g., medical instruments) free from potentially infectious living organisms. Sterilization is important for patient safety, particularly with regard to medical instrument and transplant tissue.

### SUMMARY

The present document concerns implementing systems and methods for processing a product (e.g., an organic material, a cellular material or a biological material). The methods comprise: receiving the product in a vacuum chamber (the product is enclosed within a first packaging item having at least a portion that is semi-permeable under vacuum conditions); introducing a reagent into the vacuum chamber (the reagent comprises a combination of a sterilization substance (e.g., hydrogen and/or oxygen) for sterilizing the product and a preservation substance (e.g., argon and/or nitrogen) for preserving a sterilization state of the product); causing the reagent to pass through the portion of the first packaging item that is semi-permeable such that a sterilization of the product by the sterilization substance occurs concurrently with a modification of an internal atmospheric condition within the first packaging item by the preservation substance; and preserving the sterilized state of the product via the modified internal atmospheric condition of the first packaging.

In some scenarios, the methods also comprise: emitting UV light within the vacuum chamber to further sterilize the product; introducing a supplement substance into the vacuum chamber; and/or causing the supplement substance to pass through the portion of the first packaging item that is semi-permeable and penetrate into the product. The supplement substance can include, but is not limited to, an essential oil and/or an extract.

In those or other scenarios, the methods comprises testing an oxygen level of the product after said preserving. Alternatively or additionally, the methods comprise: testing a pathogenetic quantitative state of the product subsequent to said preserving; enclosing the product in a second packaging item using modified atmospheric package technology, when the results of said testing indicate that the pathogenetic quantitative state of the product is acceptable; and/or testing an oxygen level of the product after being enclosed within the second packaging item.

The implementing systems comprise: a vacuum chamber configured to receive a product (e.g., an organic material, a cellular material or a biological material) that is enclosed within a first packaging item having at least a portion that is semi-permeable under vacuum conditions; a vaporizer configured to introduce a reagent into the vacuum chamber, the reagent comprising a combination of a sterilization substance (e.g., hydrogen and/or oxygen) for sterilizing the product and a preservation substance (e.g., argon and nitrogen) for preserving a sterilization state of the product; and a controller configured to control operations of the vacuum chamber to cause the reagent to pass through the portion of the first packaging item that is semi-permeable such that a sterilization of the product by the sterilization substance occurs concurrently with a modification of an internal atmospheric condition within the first packaging item by the preservation substance. A preservation of the sterilized state of the product is facilitated by the modified internal atmospheric condition of the first packaging.

In some scenarios, the systems may also comprise a device for emitting UV light within the vacuum chamber to facilitate further sterilization of the product. The vaporizer may be further configured to introduce a supplement substance (e.g., an essential oil and/or an extract) into the vacuum chamber. The controller may be further configured to control operations of the vacuum chamber to cause the supplement substance to pass through the portion of the first packaging item that is semi-permeable and penetrate into the product.

In those or other scenarios, the systems comprises a tester configured to test an oxygen level of the product after the sterilized state of the product has been preserved. Additionally or alternatively, the tester tests a pathogenetic quantitative state of the product subsequent to the preservation of the sterilized state of the product. Equipment may be provided that is configured to enclose the product in a second packaging item using modified atmospheric package technology, when the tester indicates that the pathogenetic quantitative state of the product is acceptable. The tester may test an oxygen level of the product after being enclosed within the second packaging item.

### BRIEF DESCRIPTION OF THE DRAWINGS

This disclosure is facilitated by reference to the following drawing figures, in which like numerals represent like items throughout the figures.

FIG. 1 provides an illustration of an illustrative system.

FIG. 2 provides an illustration of an illustrative apparatus for purifying, hydrating, and/or infusing organic and biological material.

FIG. 3 provides a flow diagram of an illustrative method for processing biological material.

FIG. 4 provides an illustration of an illustrative modular system for processing biological materials.

FIGS. 5A-5B provide photographs of an illustrative apparatus for processing biological materials.

FIG. 6 provides a graph showing an illustrative terpene analysis.

FIGS. 7A-7I provide illustrations of a system for processing biological materials.

FIG. 8 a flow diagram of an illustrative method for post-preservation processing of a sterilized biological product.

FIGS. 9-12 each provide an illustration of an illustrative MAP sterilized biological product.

FIG. 13 provides an illustration of an illustrative computing device.

### DETAILED DESCRIPTION

It will be readily understood that the solution described herein and illustrated in the appended figures could involve a wide variety of different configurations. Thus, the following more detailed description, as represented in the figures, is not intended to limit the scope of the present disclosure, but is merely representative of certain implementations in various different scenarios. While various aspects are presented in the drawings, the drawings are not necessarily drawn to scale unless specifically indicated.

The present document concerns implementing systems and methods for: (i) purification of organic, cellular and/or biological materials (e.g., plant materials); (ii) the preservation of a sterilized state of the organic, cellular and/or biological materials; and/or (iii) the infusion of one or more additives into organic, cellular and/or biological materials (e.g., purified plant materials). The implementing systems and methods can be used for: enhanced purification of and infusion of one or more components, supplements and additives into an organic, cellular and/or biological material (e.g., a plant material); and/or enhanced preservation of organic, cellular and/or biological materials so as to extend a shelf life thereof. The purification, preservation and/or infusion operations can be conducted in a serial manner, a substantially concurrent manner, or in a concurrent manner.

Effective sterilization of organisms is especially difficult in cannabis flower since the sterilization and decontamination of cannabis can impact biomarkers (e.g., Tetrahydrocannabinol (THC), Cannabidiol (CBD) and terpenes) such that they are undesirably reduced or no longer present in the sterilized and/or decontaminated cannabis flower. In some scenarios, a reactive oxygen (“rO”) system is configured to provide energy-efficient, effective, terminal decontamination of an organic, cellular or biological material (e.g., a plant material such as cannabis) with minimal or no ecological footprint. The rO system can consistently purify, sterilize, disinfect, decontaminate, hydrate/re-hydrate, remediate mold and/or reduce or eliminate microbes from a batch of the material received within a vacuum chamber of the system, thereby producing a treated/finished product that is safe for human consumption (e.g., ingesting, smoking and/or vaporizing). In some scenarios, one or more of the following microbes are reduced, inactivated or substantially eliminated using the rO system: geobacillus stearothemophilus, bacillus atrophaeus (durable andospore, gram positive equivalent E. coli), clostridium sporogenes, and Candida albicans (a fungal challenge organism). One or more supplemental materials can optionally be infused into the material using the rO system.

Preservation operations may be performed concurrent with or subsequent to the sterilization operations. The preservation operations are performed to preserve a sterilized state of the organic, cellular or biological material. This preservation is achieved by packaging the material in a package with a modified internal atmosphere. The modified internal atmosphere of the packaging is selected to ensure that the sterilized state of the material remains the same or substantially the same while the package is sealed. The modified internal atmosphere may be created by: the injection of a preservation substance into a vacuum chamber concurrent with or subsequent to the injection of a reagent and/or a supplement; or the use of Modified Atmosphere Packaging (MAP) technology upon completion of the sterilization and/or infusion operations. The particulars of the various ways the preservation operations are implemented will become evident as the discussion progresses.

In some scenarios, infusion operations are preceded or accompanied by hydration (or re-hydration) operations. For example, a multi-step process can include a purification (or sterilization) step, a preservation step, a hydration step and an infusion step, in any order, optionally with partial overlap in time and/or concurrent operation. One or more walls of the vacuum/process chamber may be heated during one or more of the multiple steps (purification, preservation, hydration and infusion). Details of the purification operations/step, preservation operations/step and the infusion operations/step are set forth below.

The hydration operations/step can include vaporizing a liquid or solvent (e.g., deionized (DI) water or reverse osmosis (RO) water (e.g., under vacuum conditions set forth herein)) such that the generated steam/vapor partially or fully hydrates the organic, cellular or biological material (e.g., a plant material) in-situ. This hydration process can be considered a re-hydration process, for example when the organic, cellular or biological material is a material that was previously dried. A dried material can be, for example, a material having a moisture content of about 4%, or between about 4% and about 11%, or between about 4% and about 7%, or between about 1% and about 5%, or between about 5% and about 10%. A material having a moisture level below 3% or 4% can be considered freeze dried or nearly freeze-dried. The hydration process can be performed to achieve a desired or predetermined moisture level within the chamber and/or within the organic, cellular or biological material, and/or to manipulate moisture levels thereof in a desired direction (e.g., increase or decrease the moisture level(s)). A material may be considered fully hydrated when it has reached a moisture level/content of up to 18%, for example about 12%, or about 15%, or between about 12% and about 18%, or between about 15% and about 18%, or between about 13% and about 17%, or between about 14% and about 16%.

As set forth herein, an infusion process can receive a starting liquid material (e.g., a sterilant (e.g., about 35% hydrogen peroxide) or an essential oil), convert the starting liquid material into a vapor, and cause the vapor to penetrate a desired material (e.g., a plant material). The penetration of the vapor into the material can be caused, for example, by a temperature gradient (e.g., where walls of a chamber in which a process occurs, the chamber walls may be at an elevated temperature (e.g., about 90° C.) with respect to the material itself (e.g., at about 70° C.). Depending on the implementation, the penetration of the vapor into the material can be complete (i.e., the material is fully penetrated by, or “saturated” with, the vapor) or partial.

The infusion process or a multi-step process (at one or more stages/steps thereof) can include the introduction of one or more nutraceuticals into the chamber, such that is the one or more nutraceuticals are infused into, absorbed by, or otherwise incorporated into the material that is being processed. For example, L-Theanine can be infused into Indica to yield a finished product for use as a sleep aid or for anti-anxiety, and Theacrine can be infused into Sativa to yield a finished product for energy and focus. The combination of the selection of the nutraceutical(s) and a selection of the material (e.g., a particular plant strain, terpene profile, concentration of a component of interest, etc.) can be used to produce a treated material (end product) having enhanced, synergistic properties (i.e., a superflower). The infusion process or a multi-step process can have an antimicrobial effect on the material being treated.

An apparatus is configured to perform a process that includes low-temperature sterilization of a bulk material (such as cannabis flower) within a vacuum chamber using a reactive oxygen (vaporized H2O2 or VH2O2) sterilant. Generating the reactive oxygen can include hydrogen peroxide vaporization (HPV). The reactive oxygen can function as a broad-spectrum antimicrobial (e.g., achieving a 5-log microbial reduction), without causing condensation of any active ingredient onto the surface of the bulk material being treated. During processing, temperature, humidity, pressure, process time and/or reactive oxygen dose (e.g., partial pressure and/or flow rate) can be controlled (e.g., via a controller and according to a pre-programmed recipe) to ensure efficacy and/or repeatability. Byproducts of the process can be limited to water and oxygen. As such, the process can be considered a completely organic sterilization process. The reactive oxygen based process may not impact the THC, CBD and/or terpene composition/profile of the bulk material. In some implementations, one or more VH2O2 biological indicators, which contain a known population of Geobacillus Stearothermophilus spores (e.g., ATCC 7953 or ATCC 12980), are used for process verification. For example, during a biodecontamination cycle of the processes set forth herein, the biolofical indicator can be inactivated by the reactive oxygen (hydrogen peroxide vapor). The inactivation can be verified using biological indicator medis, e.g., in 24-minute, 24-hour, or 7-day biodecontamination cycle results.

A biodecontamination process (or phase of a multi-step process) includes a conditioning step, an exposure step, and optionally a post-conditioning step. During the conditioning step, a concentration of a reactive oxygen (vaporized hydrogen peroxide) sterilant is brought to a desired level (e.g., within a vaporizer or a vacuum chamber that, optionally, has been evacuated to a starting base vacuum/pressure level). The sterilant vapor can be introduced to (or generated within) the vacuum chamber by a vaporizer, which flash vaporized aqueous hydrogen peroxide solution and disperses it to airstream in a controlled manner. This flash vaporization can be used to increase a concentration of the vapor inside the enclosure as quickly as possible (e.g., to a level slightly below the point of saturation). The concentration can be gradually increased inside the vacuum chamber until a desired concentration and/or associated pressure has been achieved. The exposure step begins when the desired reactive oxygen vapor concentration has been achieved within the vacuum chamber. During the exposure operation, the desired sterilant concentration (e.g., near-saturation) is maintained for a desired or pre-programmed period of time (e.g., according to a preprogrammed recipe and/or until a desired level of bioburden reduction has been achieved). An optional post-conditioning operation, following the exposure operation, can include aeration of the treated material by circulating air and reactive oxygen vapor throughout the vacuum chamber, to remove vapor from the load prior to ending the process cycle. During the post-conditioning, the vapor can be converted into water and oxygen molecules (e.g., using an integral catalytic converter system). Once the process has been completed, the chamber door can be opened to remove the finished product. The chamber door can be safely opened, for example, when sufficient time has elapsed and/or when the concentration of reactant has fallen to a sufficiently low level (e.g., as indicated by one or more measurement instruments).

The apparatuses can include novel oxygen-based purification systems configured for processing plant materials (and/or the like) that contain moisture. The systems can implement a novel Moisture-Conducive Vaporized/Aerosolized Hydrogen Peroxide (MCVAHP) process. The novel MCVAHP process may be conducted without causing damage to the processed plant materials or to the MCVAHP apparatus. By contrast, existing sterilization methods, such as those typically used for sterilizing instruments in healthcare settings, cannot effectively process moisture-containing materials—failing to properly remove/neutralize contaminants and/or destroying/degrading the moisture-containing materials.

A variety of sterilization techniques are used in the medical industry, one of the most prevalent being irradiation. However, the irradiation process can damage certain important properties of moisture containing organic materials, such as plant materials, for example, by causing undesired chemical changes, including generating free radicals, and/or (e.g., in the case of case of cannabis) by altering or destroying a terpene profile thereof, which can result in a reduction in quality of the material. Hydrogen Peroxide Vaporization (HPV) is used in hospitals to sterilize instruments, such as batteries, that are moisture sensitive (i.e., instruments that a steam autoclave could damage). Such HPV systems are not typically equipped to handle moisture—typically including a dehumidifier and/or desiccant. If a high-moisture material were placed in such an HPV unit, the HPV unit would likely shut down with an error to prevent damage, and in any event, not be able to effectively process high-moisture material.

Moreover, it has been reported that mold, fungal, and/or bacterial contamination of cannabis or tobacco products can result in illness or death in those who consume it, for example individuals/patients who are immune-compromised. Medical cannabis is frequently used by chronically ill and/or immuno-compromised patients, and several recent studies have found retail cannabis, whether dried or raw, often has multiple bacterial and fungal pathogens that can cause serious infections, such as the fungi Cryptococcus, Mucor and Aspergillus, and the bacteria E. coli, Klebsiella pneumoniae and Acinetobacter baumannii (see, e.g., Thompson III, G. R., et al. “A microbiome assessment of medical marijuana.” Clin Microbiol Infect 23.4 (2017): 269-270.)

As such, users of cannabis, including medical and recreational cannabis, would benefit from reduction of microbial contamination, reducing the potential for opportunistic lung infections. While techniques such as ionizing radiation/irradiation or heat sterilization/pasteurization could be used to for reducing contamination, they are often disfavored and include drawbacks. For example, such techniques typically require high energy, cause chemical changes, and/or cause the loss of important components such as low molecular weight compounds (e.g., terpenes, essential oils, flavors, etc.), when applied to plant materials such as cannabis or tobacco. In addition, many existing sterilization techniques are limited, only sterilizing the outside of plant materials. Since mold and mildew can originate and/or be present internally/within plant material, surface treatments are ineffective at addressing all possible contaminants.

The present solution utilizes novel oxygen-based purification, including specialized Moisture-Conducive Vaporized/Aerosolized Hydrogen Peroxide (MCVAHP) technology. The disclosed MCVAHP systems and methods that are capable of handling high-moisture-content products (such as cannabis or tobacco), including at a moisture range from about 0% to 40%, 1% to 35%, 3% to 30%, 4% to 28%, 5% to 25%, 8% to 20%, or about 10% to 16% (w/w). While not wishing be bound by any particular theory, high-moisture materials as used herein can refer to plant material with more than 15%, more than 14%, more than 13%, more than 12%, more than 11%, more than 10%, more than 9%, more than 8%, more than 7%, more than 6%, more than 5%, more than 4%, more than 3%, more than 2%, or more than 1% moisture, either on a total weight basis, a wet weight basis, or otherwise, depending on the embodiment. The disclosed systems and methods are significantly more effective (i.e., 95%, 98%, or 99% more effective) at sterilizing and/or reducing the bioburden such plant materials than was previously possible, for example, capable of reducing a mold count from 600,000 CFU to less than about 100,000 CFU, less than about 75,000 CFU, less than about 50,000 CFU, less than about 40,000 CFU, less than about 30,000 CFU, less than about 20,000 CFU, less than about 15,000 CFU, less than about 10,000 CFU, less than about 9,000 CFU, less than about 8,000 CFU, less than about 7,000 CFU, less than about 6,000 CFU, less than about 5,000 CFU, less than about 4,000 CFU, less than about 3,000 CFU, less than about 2,000 CFU, less than about 1,000 CFU, less than about 900 CFU, less than about 800 CFU, less than about 700 CFU, less than about 600 CFU, less than about 500 CFU, less than about 400 CFU, less than about 300 CFU, less than about 200 CFU, less than about 100 CFU, less than about 90 CFU, less than about 80 CFU, less than about 70 CFU, less than about 60 CFU, less than about 50 CFU, less than about 40 CFU, less than about 30 CFU, less than about 20 CFU, less than about 10 CFU, less than about 9 CFU, less than about 8 CFU, less than about 7 CFU, less than about 6 CFU, less than about 5 CFU, less than about 4 CFU, less than about 3 CFU, less than about 2 CFU, less than about 1 CFU, or about 0 CFU.

Cannabis has long history of use for medicinal purposes, industrial purposes, and as a recreational drug. Industrial hemp products are made from cannabis plants selected to produce an abundance of fiber. Some strains have been bred to produce minimal levels of THC, the principal psychoactive constituent responsible for the psychoactivity associated with marijuana. Marijuana has historically consisted of the dried flowers of cannabis plants selectively bred to produce high levels of THC and other psychoactive cannabinoids. Various extracts including hashish and hash oil are also produced from the plant.

Cannabis plants produce a unique family of terpeno-phenolic compounds called cannabinoids. Cannabinoids, terpenoids, and other compounds are secreted by glandular trichomes that occur most abundantly on the floral calyxes and bracts of female plants. As a drug it usually comes in the form of dried flower buds (marijuana), resin (hashish), or various extracts collectively known as hashish oil. There are at least 483 identifiable chemical constituents known to exist in the cannabis plant (Rudolf Brenneisen, 2007, Chemistry and Analysis of Phytocannabinoids (cannabinoids produced by cannabis) and other Cannabis Constituents, In Marijuana and the Cannabinoids, El Sohly, ed.; incorporated herein by reference) and at least 85 different cannabinoids have been isolated from the plant. The two cannabinoids usually produced in greatest abundance are CBD and/or Δ9-tetrahydrocannabinol (THC). THC is psychoactive while CBD is not.

Cannabinoids are the most studied group of secondary metabolites in cannabis. Most exist in two forms, as acids and in neutral (decarboxylated) forms. The acid form is designated by an “A” at the end of its acronym (i.e., THCA). The phytocannabinoids are synthesized in the plant as acid forms, and while some decarboxylation does occur in the plant, it increases significantly post-harvest and the kinetics increase at high temperatures. The biologically active forms for human consumption are the neutral forms. Decarboxylation is usually achieved by thorough drying of the plant material followed by heating it, often by either combustion, vaporization, or heating or baking in an oven. Unless otherwise noted, references to cannabinoids in a plant include both the acidic and decarboxylated versions (e.g., CBD and CBDA).

The cannabinoids in cannabis plants include, but are not limited to, Δ9-Tetrahydrocannabinol (Δ9-THC), Δ8-Tetrahydrocannabinol (Δ8-THC), Cannabichromene (CBC), Cannabicyclol (CBL), CBD, Cannabielsoin (CBE), Cannabigerol (CBG), Cannabinidiol (CBND), Cannabinol (CBN), Cannabitriol (CBT), and their propyl homologs, including, but are not limited to cannabidivarin (CBDV), Δ9-Tetrahydrocannabivarin (THCV), cannabichromevarin (CBCV), and cannabigerovarin (CBGV). Non-THC cannabinoids can be collectively referred to as “CBs”, wherein CBs can be one of THCV, CBDV, CBGV, CBCV, CBD, CBC, CBE, CBG, CBN, CBND, and CBT cannabinoids. Methods for administration of medical cannabis include, but are not limited, to vapor inhalation, smoking (e.g., dried buds), drinking, eating extracts or food products infused with extracts, and taking capsules.

As detailed herein, the novel MCVAHP methods, systems, and apparatuses can be utilized on organic materials, especially plant materials, such as cannabis flower material, to reduce, substantially eliminate, essentially eliminate, or eliminate harmful microbes and/or the risk therefrom for legal users, while providing supplements to said organic materials.

Illustrative System

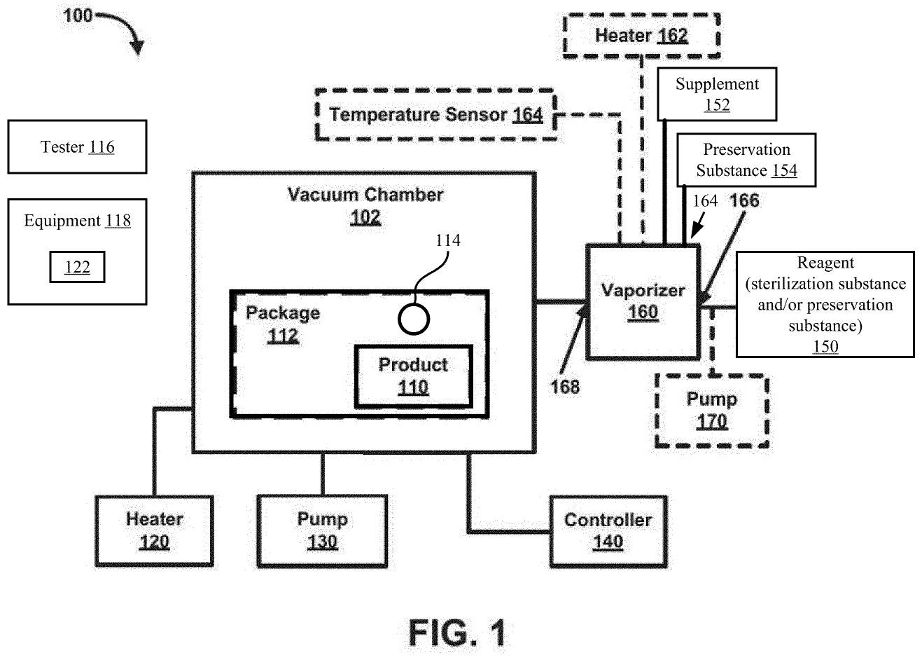

Referring now to FIG. 1, there is provided an illustration of an illustrative system 100 for purifying, preserving, hydrating and/or infusing organic, cellular and/or biological materials (e.g., plant materials). A product 110 (e.g., one or more items) is placed into a package 112. The package 112 can comprise one or more medical-grade materials. The package 112 is designed such that at least a portion 114 thereof is semi-permeable under at least vacuum conditions. The package may not be semi-permeable under standard atmospheric conditions (e.g., pressure). For example, in some scenarios, the package 112 comprises a bag formed of two materials coupled to each other (e.g., via an adhesive or weld). The two materials include a semi-permeable material (e.g., Tyvek) defining a first side of the bag and a clear plastic material defining a second opposing side of the bag. The present solution is not limited to the particulars of this example. For example, the package 112 can alternatively comprise a bag formed of a clear plastic material. A small area of the clear plastic material is cut out and replaced with a semi-permeable material.

Once the product 110 has been properly prepared and packaged, it is placed into the system's vacuum chamber 102. The vacuum chamber 102 can have a size to accommodate one or more packages (e.g., up to 200 packages). Each package may have a mass when filled with plant product material of 0.5 grams to 5 kg. The vacuum chamber 102 can have any capacity suitable for the processing of a plant material (e.g., up to or exceeding about 5 pounds of plant material). The vacuum chamber 102 can be preheated (e.g., by a heater 120) to a temperature in a range from about 20° C.-55° C. The temperature can be selected based on the material, and the system can be configured accordingly.

After the product 110 has been placed in the vacuum chamber 102, a door (not shown in FIG. 1) of the vacuum chamber 102 is closed and sealed. The heated vacuum chamber 102 provides an environment in which a subsequently-introduced multi-purpose reagent 150 can become evenly dispersed throughout the vacuum chamber 102 and/or the product 110. Notably, the multi-purpose reagent 150 is configured to (i) sterilize the product 110 and/or packaging 112, and (ii) preserve a sterilized state of the product 110 while the package 112 is sealed. The multi-purpose reagent 150 is able to reach the product 110 when packaged since the package 112 is at least partially semi-permeable under vacuum conditions.

Once the vacuum chamber door has been sealed, a processing procedure is initiated, for example, by an individual using a controller 140 or other interface means. The processing procedure is implemented by the system 100 via a software program installed on the controller 140 and/or other component thereof. Controller 140 can include, but is not limited to, a computing device having data store(s) (e.g., a memory), processor(s), system interface(s), and/or input device(s)/output device(s). The input device(s)/output device(s) can include, but is(are) not limited to, a keyboard, a touchscreen, a display, Graphical User Interface(s) (GUI(s)), and/or a Human Machine Interface (HMI) screen. System 100 can be controlled via one or more Programmable Logic Controllers (PLCs), e.g., utilizing Ladder Logic. Within the software program, one or more variables of the system's operation can be controlled. The variables can be controlled throughout the processing procedure manually and/or programmatically, and may or may not be guided/controlled by feedback from one or more sensors, monitors or other devices of system 100.

In some scenarios, the processing procedure involves performing a purification process or a joint purification-preservation process over the course of a cycle. The cycle may have a duration, for example, of about 1 minute to about 6 hours, including about 2 minutes, 3 minutes, 4 minutes, 5 minutes, 6 minutes, 7 minutes, 8 minutes, 9 minutes, 10 minutes, 11 minutes, 12 minutes, 13 minutes, 14 minutes, 15 minutes, 16 minutes, 17 minutes, 18 minutes, 19 minutes, 20 minutes, 21 minutes, 22 minutes, 23 minutes, 24 minutes, 25 minutes, 26 minutes, 27 minutes, 28 minutes, 29 minutes, 30 minutes, 31 minutes, 32 minutes, 33 minutes, 34 minutes, 35 minutes, 36 minutes, 37 minutes, 38 minutes, 39 minutes, 40 minutes, 41 minutes, 42 minutes, 43 minutes, 44 minutes, 45 minutes, 46 minutes, 47 minutes, 48 minutes, 49 minutes, 50 minutes, 51 minutes, 52 minutes, 53 minutes, 54 minutes, 55 minutes, 56 minutes, 57 minutes, 58 minutes, 59 minutes, 60 minutes, 70 minutes, 80 minutes, 90 minutes, 120 minutes, 150 minutes, 180 minutes, 240 minutes, 300 minutes, or about 360 minutes, etc., in some implementations, from about 16 minutes to about 42 minutes.

Both of the purification process and the joint purification-preservation process include, but are not limited to: heating the vacuum chamber 102 (e.g., to temperature from about 15° C. to about 70° C., including about 20° C., about 25° C., about 30° C., about 35° C., about 40° C., about 45° C., about 50° C., about 55° C., about 60° C., or about 65° C.); heating a vaporizer 160 (e.g., from about 15° C. to about 250° C. depending on the reagent to be vaporized/aerosolized) using heater 162; monitoring a temperature of the vaporizer 160 using a temperature sensor 164; loading the reagent(s) 150 at the appropriate concentration into a reagent receptacle; priming the reagent 150; evacuating the vacuum chamber 102 (e.g., by activating a vacuum to a base pressure from about 1 Torr to about 750 Torr); and injecting the reagent 150 into the vaporizer 160 (e.g., from about 1 cc to about 25 cc of reagent). The reagent 150 may be pumped via a liquid reagent input port 166 of the vaporizer 160 using a pump 170 or actuator. During the injection operation, the reagent 150 may be transformed from a liquid to a gas, vapor or aerosol. The reagent may then be introduced into the vacuum chamber 102 via an output port 168 of the vaporizer 160.

In the purification process, the reagent 150 includes only a sterilization substance. The sterilization substance can include, but is not limited to, an oxygen-based substance (e.g., H₂O₂). In the joint purification-preservation process, the reagent 150 comprises a single purpose reagent or a multi-purpose reagent. The single purpose reagent may be employed when the sterilization is to be achieved using ultraviolet (UV) light rather than a sterilization constituent. The multi-purpose reagent may be employed when UV light is not to be used to sterilize the items 110, 112 and/or the UV light is to be used in addition to a sterilization substance. Accordingly, the single-purpose reagent comprises a preservation substance. The multi-purpose reagent includes a mixture of a sterilization substance and a preservation substance. The sterilization substance can include, but is not limited to, an oxygen-based substance (e.g., H₂O₂). The preservation substance can include, but is not limited to, nitrogen and/or argon.

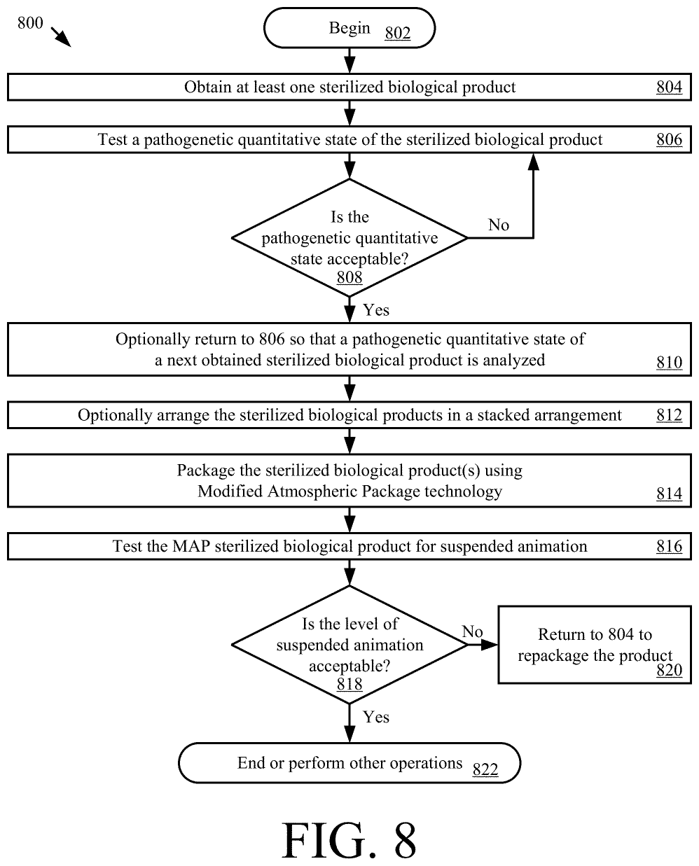

The product 110 may then be allowed to dwell inside the vacuum chamber 102 for an amount of time that is sufficient for (i) the sterilization constituent of the multi-purpose reagent 150 to penetrate into the product 110 and/or (ii) the preservation constituent of the multi-purpose reagent 150 to diffuse into the package 112 so as to change or modify the internal atmospheric conditions thereof. It should be noted that (i) and (ii) occur serially in the purification process scenarios. (ii) may be performed after the processing procedure is completed as discussed below in relation to FIG. 8. In contrast, (i) and (ii) can occur concurrently or simultaneously during the joint purification-preservation process. This is a novel and important feature of the present solution since it decreases the overall time and cost to process and sufficiently package the product 110 for an increased shelf-life as compared to other product preparation/packaging techniques.

A cycle of the purification process and/or the joint purification-preservation process can have a duration of 30 seconds, 45 seconds, 60 seconds, 2 minutes, 3 minutes, 4 minutes, 5 minutes, 6 minutes, 7 minutes, 8 minutes, 9 minutes, 10 minutes, 11 minutes, 12 minutes, 13 minutes, 14 minutes, 15 minutes, 16 minutes, 17 minutes, 18 minutes, 19 minutes, 20 minutes, 30 minutes, 45 minutes, 60 minutes, 90 minutes, 120 minutes, 150 minutes, 180 minutes, 240 minutes, 300 minutes, 360 minutes, 420 minutes, 480 minutes, 540 minutes, or any integers there between. In some scenarios, the total purification time of all cycles of the purification process and/or the joint purification-preservation process is about 2 minutes, 3 minutes, 4 minutes, 5 minutes, 6 minutes, 7 minutes, 8 minutes, 9 minutes, 10 minutes, 11 minutes, 12 minutes, 13 minutes, 14 minutes, 15 minutes, 16 minutes, 17 minutes, 18 minutes, 19 minutes, 20 minutes, 30 minutes, 45 minutes, 60 minutes, 90 minutes, 120 minutes, 150 minutes, 180 minutes, 240 minutes, 300 minutes, 360 minutes, 420 minutes, 480 minutes, 540 minutes, or any integers therebetween.

The items 110, 112 can be exposed to one or more pressures during the purification process and/or the joint purification-preservation process. In this regard, system 100 can include pumps, valves and/or other devices to facilitate a change in pressure within the vacuum chamber 102 in a controlled manner. The items 110, 112 can be exposed to a target pressure or a series of set point pressures. The internal pressure of the vacuum chamber 102 typically follows a curve or line as it changes from an initial pressure (e.g., atmospheric or external pressure) to or towards the target pressure or an initial set point pressure based on pre-defined pressure parameters. For example, the pressure in the vacuum chamber 102 may be selectively varied (e.g., between about 1 Torr and about 750 Torr and/or any integers there between) during the purification process and/or the joint purification-preservation process. The state of the reagent 150 may be altered by the varying pressure. One or more cycles may be performed to saturate the product 110 with the reagent 150. The cycles can have the same or different durations and pressures.

After completion of the purification process or the joint purification-preservation process, a vent of the vacuum chamber 102 may be opened so that the pressure therein is reduced to an atmospheric pressure (i.e., about 760 Torr). The reagent 150 is able to travel out of the vacuum chamber 102 to the ambient atmosphere and/or to a recovery/reclamation device during the venting.

Subsequently, a vacuum cleaning process may be performed that involves one or more (e.g., two) additional vacuum cleaning stages for eliminating any residual or remaining reagent from the vacuum chamber 102 and/or an external surface of the item 110/112.

Next in some scenarios, an infusion process is performed after the completion of the purification process and/or the joint purification-preservation process. The infusion process is performed so that one or more supplements 152 can added to the product 110. The supplement(s) 152 can include, but is(are) not limited to, essential oil(s) and/or extract(s). The infusion process is performed over the course of a cycle having a duration, for example, of about 8 minutes to about 25 minutes.

The infusion process may comprise: heating the vacuum chamber 102 to a pre-defined temperature; heating the vaporizer 160 to a pre-defined temperature using heater 162; monitoring a temperature of the vaporizer 160 using a temperature sensor 164; loading the supplement 152 in a dispenser (not shown); priming the supplement 152; evacuating the vacuum chamber 102 (e.g., activate vacuum to a base pressure of between about 3 Torr to about 750 Torr); dispensing or otherwise injecting the supplement 152 (e.g., into the vaporizer 160) into the vacuum chamber 102; and/or allowing the product 110 to dwell for a given amount of time (e.g., an amount of time that is sufficient for the supplement 152 to diffuse through the package 112 and penetrate into the product 110).

During the infusion process, the pressure and/or temperature of the vacuum chamber 102 can be varied such that the product 110 is properly and adequately infused with the supplement 152. The infusion process can include a cycle at a pressure greater than atmospheric pressure. Unlike the purification process, the infusion process does not conclude with (or include at all) a cleaning cycle. During the infusion process priming operation, a liquid supplement can be primed from a bottle or other dispenser into the vaporizer 160. The supplement 152 can be recovered from a recovery/reclamation device (i.e., replacing one or more components of the product that was lost and captured during purification. The vaporizer 160 is constructed from one or more metals or metal alloys (e.g., 6061 aluminum). The liquid supplement can include, but is not limited to, essential oil(s), extract(s) and/or synthetic equivalent of a natural component of the product (e.g., for cannabis, one or more cannabinoid oils, terpenes, terpinoids, flavonoids, cannaflavins, THC, CBD which may be isolated, in combination, and/or in solution with a base or carrier, H2O, and/or the like).

Prior to or after the infusion process, a subsequent preservation process may be performed to preserve the sterilized and/or decontaminated state of the product 110. The preservation process may be employed when the purification process and not the joint purification-preservation process was previously performed.

The preservation process can be performed over the course of a cycle. The cycle may have a duration, for example, of about 1 minute to about 6 hours, including about 2 minutes, 3 minutes, 4 minutes, 5 minutes, 6 minutes, 7 minutes, 8 minutes, 9 minutes, 10 minutes, 11 minutes, 12 minutes, 13 minutes, 14 minutes, 15 minutes, 16 minutes, 17 minutes, 18 minutes, 19 minutes, 20 minutes, 21 minutes, 22 minutes, 23 minutes, 24 minutes, 25 minutes, 26 minutes, 27 minutes, 28 minutes, 29 minutes, 30 minutes, 31 minutes, 32 minutes, 33 minutes, 34 minutes, 35 minutes, 36 minutes, 37 minutes, 38 minutes, 39 minutes, 40 minutes, 41 minutes, 42 minutes, 43 minutes, 44 minutes, 45 minutes, 46 minutes, 47 minutes, 48 minutes, 49 minutes, 50 minutes, 51 minutes, 52 minutes, 53 minutes, 54 minutes, 55 minutes, 56 minutes, 57 minutes, 58 minutes, 59 minutes, 60 minutes, 70 minutes, 80 minutes, 90 minutes, 120 minutes, 150 minutes, 180 minutes, 240 minutes, 300 minutes, or about 360 minutes, etc., in some implementations, from about 16 minutes to about 42 minutes.

The preservation process includes, but is not limited to: heating the vacuum chamber 102 (e.g., to temperature from about 15° C. to about 70° C.); heating a vaporizer 160 (e.g., from about 15° C. to about 250° C.) using heater 162; monitoring a temperature of the vaporizer 160 using a temperature sensor 164; loading a preservation substance 154 at the appropriate concentration into a receptacle; priming the preservation substance 154; evacuating the vacuum chamber 102 (e.g., by activating a vacuum to a base pressure from about 1 Torr to about 750 Torr); and injecting the preservation substance 154 into the vaporizer 160. The preservation substance 154 may be pumped via an input port 164 of the vaporizer 160 using a pump 170 or actuator. During the injection operation, the preservation substance 154 may be transformed from a liquid to a gas, vapor or aerosol. The preservation substance 154 may then be introduced into the vacuum chamber 102 via the output port 168 of the vaporizer 160. The items 110, 112 may then be allowed to dwell inside the vacuum chamber 102 for an amount of time that is sufficient for the preservation substance 154 to diffuse into the package 112 so as to change or modify the internal atmospheric conditions thereof. The preservation substance can include, but is not limited to, nitrogen and/or argon.

As shown in FIG. 1, the vaporizer 160 includes: a port for a heater 162 (e.g., a 220V cartridge-style electric heater); a port for a temperature sensor/gauge 164; an input port 166; and/or an output port 168. During the above-described processing procedure, the reagent 150 and supplement 152 are injected into the vaporizer 160 chamber. In this regard, the vaporizer 160 is connected to (i.e., is in fluid communication with) the vacuum chamber 102. A vacuum pressure of the vaporizer 160 may be set to the same or substantially similar pressure of the vacuum chamber 102 (i.e., whatever the pressure set-point of the vacuum chamber, the same or similar pressure is present inside the vaporizer). A presence of a vacuum (i.e., a pressure that is below atmospheric pressure) inside the vaporizer 160 chamber may facilitate the vaporization of liquids at lower temperatures than would be sufficient if the processing procedure were performed at atmospheric pressure. The pressure and/or temperature can be adjusted to optimize the processing procedure based on the type of reagent 150 and/or supplement 152 being used.

When the reagent 150 and/or supplement 152 is injected into the chamber of the vaporizer 160, it can be instantly, substantially instantly or quickly vaporized or aerosolized into a gaseous state or aerosol, and drawn or pulled into the vacuum chamber 102. As the reagent 150 or supplement 152 is being drawn/pulled into the vacuum chamber 102, it migrates toward lower-temperature surface(s) within the vacuum chamber. The liquid reagent 150 and/or supplement 152 may be attracted to the product 110 as the product can be the coolest location within the vacuum chamber 102. The product 110 may be chilled prior to processing procedure.

### Example I

An example purification process was performed using a vaporizer temperature of about 110° C. (i.e., such that the reactant gas migrates to one or more lower-temperature regions within the vacuum chamber), a vacuum chamber temperature of about 40° C. (gas moves again to lower temp area), and a product temperature (inside the product package) of about 20° C. to about 30° C.

(1) Diffusion

During the purification process, the reagent gas was diffused into the product at different pressures, since changes in pressure affect the state of the gas in the process (i.e., the lower the vacuum, the dryer the gas; the higher the vacuum, the greater the moisture content of the gas). The reagent gas was driven or pushed toward the center of the product under high vacuum (e.g., a first pressure value of about 3 Torr to about 100 Torr) and retained there for a first predetermined exposure duration. After the first predetermined exposure duration has elapsed, the vacuum chamber pressure is increased to a first increased pressure value (e.g., to about 50 Torr to about 200 Torr) and held at the first increased value for a second predetermined exposure duration. After the second exposure duration has elapsed, the vacuum chamber pressure is again raised to a second increased pressure value (e.g., to about 250 Torr to about 600 Torr) and held at the second increased value for a third predetermined exposure duration. The first predetermined exposure duration, the second predetermined exposure duration, and the third predetermined exposure duration correspond to three distinct stages of diffusion during which purification (and/or, in some embodiments, infusion) occurs.

(2) Cleaning

The fmal stage of the purification process included venting the residual/remaining gas out of the vacuum chamber by venting the vacuum chamber to atmospheric pressure (about 760 Torr). Two substantially identical vacuum processes were then performed, in which the vacuum chamber was evacuated to a pressure of about 3-700 Torr (i.e., a holding pressure) and held at that pressure value for a given period (here, between about 5 second and about 30 seconds, though it can be different or the same for other scenarios). The vacuum chamber was then vented back to atmospheric pressure. As noted above, these final two operations are used in the purification process to remove any remaining reagent, but in most scenarios are not used in infusion processes of the present disclosure, since the intention with infusion is to retain the reagents within the product.

The present disclosure contemplates that, in some instances, systems, apparatuses, and/or methods described above can be combined such that a product received with a vacuum chamber receives both purification, preservation and/or infusion treatments, for example, either sequentially/serially or substantially concurrently.

In some scenarios, the product 110 is tested by a tester 116 for quality control (QC) purposes after it has been removed from the vacuum chamber 102. This testing can include, but is not limited to: testing a pathogenetic quantitative state of the product; and/or testing the product enclosed within a packaging item (e.g., package 112 of FIG. 1) for suspended animation or a level of oxygen. The term “suspended animation” as used here refers to a lack of oxygen or an acceptable amount of oxygen (i.e., an amount of oxygen that is equal to or less than a pre-defined threshold amount). This testing is achieved using a commercially available headspace gas analyzer. The headspace gas analyzer ensures that the residual oxygen in the product complies with a pre-defined limit. If the amount of residual oxygen exceeds the pre-defined limit, then the level of suspended animation is deemed unacceptable. In this case, the product may be re-tested, re-processed and/or re-packaged. If the amount of residual oxygen is equal to or does not exceed the pre-defined limit, then the level of suspended animation is deemed acceptable. In this case, the finalized, treated and validated material (finished product) is output from the system 100, stored in a storage facility and/or provided to a business entity (e.g., a supplier) or individual (e.g., a consumer).

In those or other scenarios, the product 110, 110/112 is enclosed in a packaging item 122 by equipment 118. The equipment 118 is configured to enclose the product 110, 110/112 in a packaging item 122 using modified atmospheric package technology, when the results of the testing indicate that the pathogenetic quantitative state of the product is acceptable. The tester 116 may test an oxygen level of the product after being enclosed within the packaging item 122.

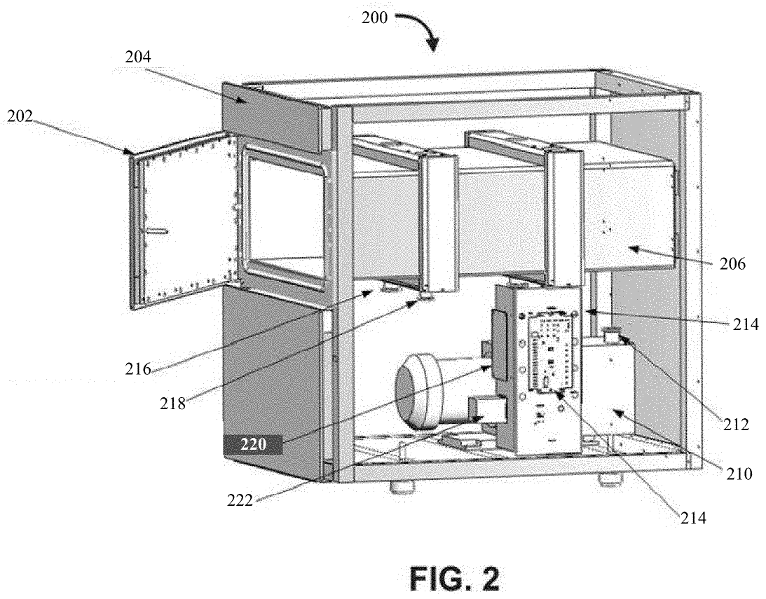

Referring now to FIG. 2, there is provided an illustration of an illustrative apparatus 200 for purifying, hydrating, and/or infusing organic and biological material. As shown in FIG. 2, the apparatus 200 includes a housing with a chamber door 202 and a display 204 (e.g., including a graphical user interface (GUI)) affixed thereto. A vacuum chamber 206, with chamber heaters and insulation, is disposed within the housing and accessible via the chamber door 202. A temperature sensor 216 and a vacuum gauge 218 are disposed on brackets holding the vacuum chamber 206 in place, and are at least one of in physical contact with or in fluid communication with the vacuum chamber 206. Also included within the housing is: a vacuum pump 210 that is in fluid communication with the vacuum chamber 206 and optionally includes an oil mist eliminator port 212; a controller 214; a peristaltic pump 222; a vaporizer 208; and a power supply 220. The power supply 220 can supply power to the vacuum pump 210, the controller 214, the peristaltic pump 222, the chamber heaters 206, the vaporizer 208, the vacuum gauge 218, the temperature sensor 216 and/or the display 204. Although some of the foregoing components are shown and described as being co-located within a common housing, it is to be understood that other configurations, including configurations in which some (i.e., any subset thereof) or all of the components are positioned without or outside a housing, are also contemplated.

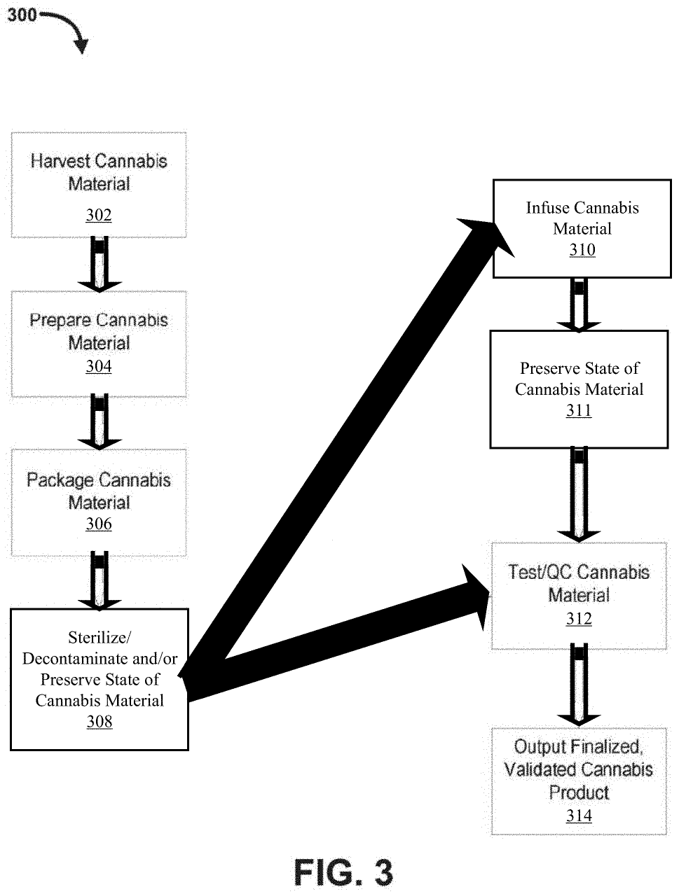

Referring now to FIG. 3, there is provided a flow diagram of an illustrative method 300 for processing a material. The material can include, but is not limited to, a cannabis material. Method 300 begins with 302 where a material is harvested. Next in 304 and 306, the material is prepared and/or packaged. The material is sterilized, decontaminated and/or preserved in 308 (optionally with heated chamber walls during the purification process or the joint purification-preservation process). Thereafter, method 300 continues with 310-311 or 312. 310 involves infusing the material. 311 involves preserving a sterilized and/or decontaminated state of the cannabis material. Upon completing 311, method 300 continues with 312.

312 involves testing the material for quality control (QC) purposes. This testing can include, but is not limited to, testing the product enclosed within a packaging item (e.g., package 112 of FIG. 1) for suspended animation or a level of oxygen. The term “suspended animation” as used here refers to a lack of oxygen or an acceptable amount of oxygen (i.e., an amount of oxygen that is equal to or less than a pre-defined threshold amount). This testing is achieved using a commercially available headspace gas analyzer. The headspace gas analyzer ensures that the residual oxygen in the product complies with a pre-defined limit. If the amount of residual oxygen exceeds the pre-defined limit, then the level of suspended animation is deemed unacceptable. In this case, the product may be re-tested, re-processed and/or re-packaged. If the amount of residual oxygen is equal to or does not exceed the pre-defined limit, then the level of suspended animation is deemed acceptable. In this case, method 300 continues with 314 where the finalized, treated and validated material (finished product) is output.

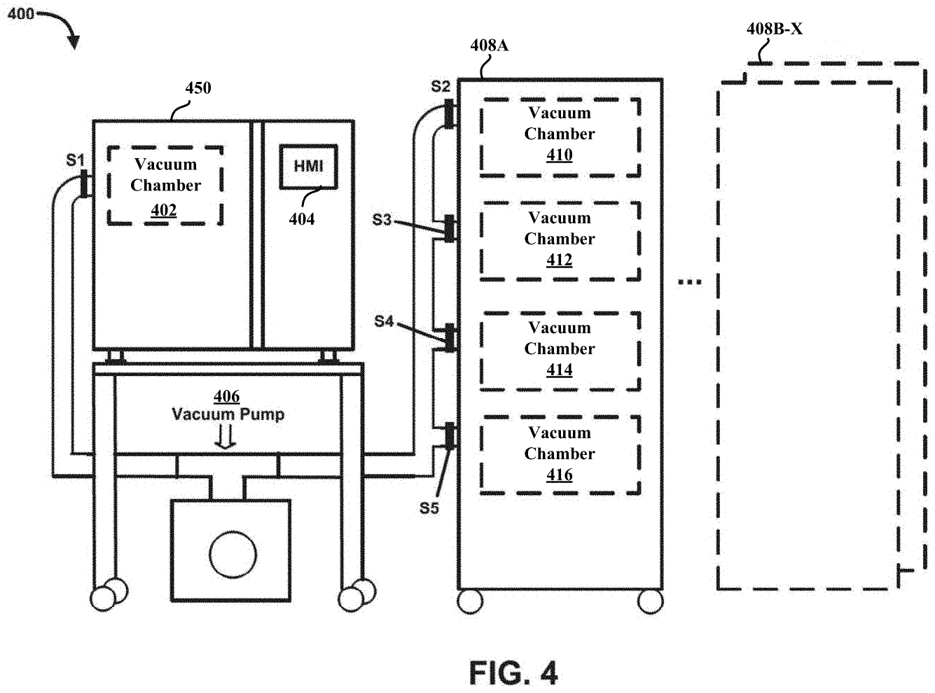

Referring now to FIG. 4, there is provided an illustration of an illustrative modular system for purifying, hydrating and/or infusing organic and biological material. Modular system 400 comprises an apparatus 450 which may be similar to the apparatus 200 of FIG. 2. Apparatus 450 has a vacuum chamber 402 and an HMI 404 (e.g., a GUI or other input/display component). The apparatus 450 may include, but is not limited to, a table top control unit that may be mounted on a table. A vacuum pump 406 is disposed below the apparatus 450. The vacuum pump 406 is in fluid communication, via tubing/piping and vacuum connectors, with the vacuum chamber 402. The vacuum pump 406 is configured, during operation, to pull a vacuum on the vacuum chamber 402. The HMI 404 can be communicatively coupled to a processor and a memory storing processor-executable instructions to perform process recipes within the apparatus 450 (and, more specifically, within the vacuum chamber 402). The processor and/or memory can be disposed within the housing of the apparatus 450, attached directly thereto (i.e., hardwired), or communicably accessible via a wired or wireless network connection.

The modular system 400 also comprises at least one additional vacuum chamber 410, 412, 414, 416 that is also in fluid communication with the vacuum pump 406. Vacuum pump 406 can evacuate (pull vacuum on) the vacuum chamber(s) 410, 412, 414, 416. Each vacuum chamber 402, 410, 412, 414, 416 is coupled to the vacuum pump 406 via a pipe and a valve (e.g., solenoid valves) at S1, S2, S3, S4, S5. The HMI 404 can also be used to control process recipes occurring in the vacuum chamber(s) 410, 412, 414, 416, in addition to those taking place in vacuum chamber 402. For example, as part of a given process recipe, the HMI 404 may control one or more of the valves S1-S5, the vacuum pump 406, and/or additional component(s) (not shown) (e.g., a heater, a vaporizer, a gas inlet (e.g., for oxygen and/or nitrogen), a mass flow controller, a liquid inlet (e.g., for DI or RO water), a vacuum gauge or sensor, a pressure gauge, a temperature sensor, etc.). The vacuum chamber(s) 410, 412, 414, 416 can be housed within a common enclosure (e.g., a cart, rack, or “floor stand”) 408A and/or additional enclosure(s) 408B-X. One or more vacuum pumps can be optionally included such that system 400 is expandable/scalable. Modular system 400 facilitates increased processing throughput of materials, since multiple “batches” of the material or multiple different types of material can be concurrently processed within vacuum chambers 402, 410-416.

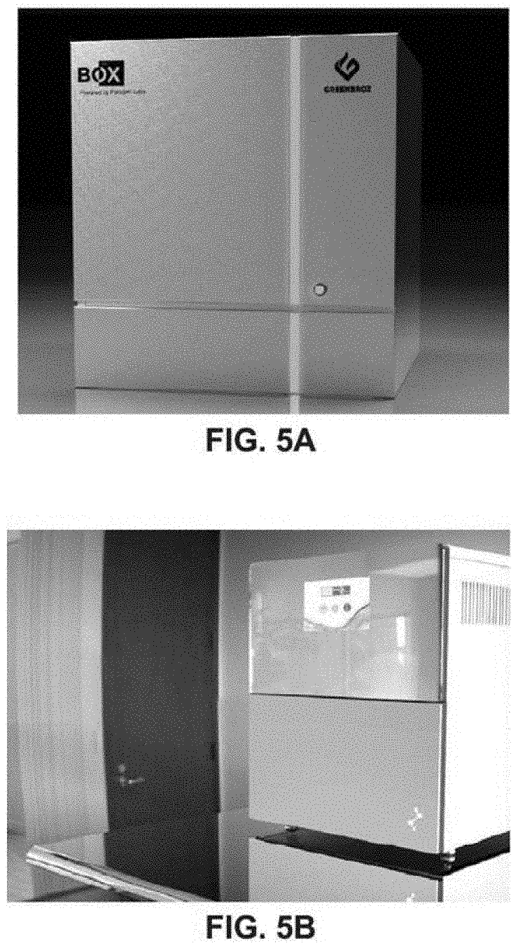

Referring now to FIGS. 5A-5B, there are provided photographs of an apparatus for purifying, preserving, hydrating and/or infusing organic and biological material. The apparatus may be have a recipe run time of about 17 minutes or less, a throughput of up to about 5 pounds of material per chamber per run, a size of about 32″ tall by about 32″ wide by about 36″ deep, a weight of about 154 pounds, an ability to eliminate up to 600,000 CFU of pathogens during a purification run, and a capability (e.g., a processor-implemented capability) to track one or more of a number of runs, process run results, user information, equipment status, etc. (e.g., with a smart phone or other portable compute device in operable communication with the apparatus or a controller thereof).

In some scenarios, the apparatus has the characteristics shown in the following TABLE 1.

TABLE 1

| | |
|---|---|
| Type of Technology | Reactive Oxygen |
| Packaged Sterilization Option | Yes |
| Flower Infusion with Terpenes, | Yes |
| Essential Oil, & Nutraceuticals | |
| Low Temperature Sterilization | Yes |
| Process Time | 17 minutes |
| Purification to Center of Flower | Yes |
| Maximum CFU Ability | 600,000 |
| In-Process Proof of Sterilization (BI) | Yes |
| Purification of Visible Powder Mildew | Yes |
| Batch Size | 5-7 pounds |
| Nitrogen Preservation | Yes |

Example Validation Data

Three batches of cannabis (Dream Queen strain) and five batches of cannabis (Kings Kush strain) were processed using an apparatus and method of the present disclosure. The final, sterilized product (the processed cannabis) was analyzed for cannabinoid preservation. The results are shown in the following TABLE 2.

TABLE 2

| | | | B | | | | |
|---|---|---|---|---|---|---|---|
| STRAIN | | THCa | Myrcene | Ocimene | Caryophilene | Limonene | Pinene |
| Dream | Before | 22.9 | 22.7 | 5.9 | 3 | 1.5 | 1.3 |
| Queen | After | 24.8 | 21.9 | 4.5 | 2.6 | 1.4 | 1.2 |
| Dream | Before | 26.3 | 22.4 | 5.8 | 3 | 1.5 | 1.4 |
| Queen | After | 21.6 | 21.1 | 4.5 | 2.9 | 1.4 | 1.3 |
| Dream | Before | 23 | 21 | 5.3 | 2.8 | 1.4 | 1.2 |
| Queen | After | 23.2 | 20.8 | 4.7 | 2.7 | 1.4 | 1.2 |
| King's | Before | 21.8 | 26.7 | 4.7 | 2.7 | 1.3 | 0.7 |
| Kush | After | 25.3 | 25.8 | 4 | 2.5 | 1.1 | 0.7 |
| King's | Before | 22.3 | 22.6 | 5.7 | 2.8 | 1.4 | 1.3 |
| Kush | After | 22.2 | 22.9 | 5.5 | 2.7 | 1.5 | 1.2 |
| King's | Before | 24.4 | 23.6 | 5.5 | 2.1 | 1.2 | 1.4 |
| Kush | After | 24.1 | 23.9 | 5.5 | 2.2 | 1.1 | 1.2 |
| King's | Before | 24.2 | 18.1 | 4.6 | 2.5 | 1.4 | 1.2 |
| Kush | After | 23.2 | 18.0 | 4.8 | 2.1 | 1.2 | 1.1 |
| King's | Before | 22.9 | 23.6 | 5.5 | 2.6 | 1.5 | 1.3 |
| Kush | After | 22.2 | 22.9 | 5.6 | 2.2 | 1.3 | 1.3 |

Six batches of cannabis (Rug Burn strain) were processed using an apparatus and method of the present disclosure. The final, sterilized product (the processed cannabis) was analyzed for potency preservation. The results are shown in following TABLE 3.

TABLE 3

| BATCH | | THCa | THC | CBN | CBD | CBDa |
|---|---|---|---|---|---|---|
| 1 | Pre-Sterilization | 22.75% | 1.62% | 0.17% | 0.12% | 1.40% |
| | Post-Sterilization | 22.05% | 1.91% | 0.13% | 0.10% | 1.42% |
| 2 | Pre-Sterilization | 22.99% | 1.82% | 0.17% | 0.10% | 1.50% |
| | Post-Sterilization | 22.05% | 1.83% | 0.16% | 0.10% | 1.43% |
| 3 | Pre-Sterilization | 23.85% | 1.69% | 0.20% | 0.11% | 1.47% |
| | Post-Sterilization | 23.05% | 1.70% | 0.19% | 0.10% | 1.43% |
| 4 | Pre-Sterilization | 23.78% | 1.70% | 0.17% | 0.12% | 1.52% |
| | Post-Sterilization | 23.80% | 1.69% | 0.16% | 0.11% | 1.53% |
| 5 | Pre-Sterilization | 22.25% | 1.81% | 0.16% | 0.12% | 1.49% |
| | Post-Sterilization | 22.05% | 1.81% | 0.15% | 0.11% | 1.43% |
| 6 | Pre-Sterilization | 22.05% | 1.62% | 0.16% | 0.11% | 1.44% |
| | Post-Sterilization | 22.06% | 1.89% | 0.16% | 0.10% | 1.43% |

Fifteen batches/sample of dried cannabis flower were processed using an apparatus and method of the present disclosure. The final, sterilized product (the processed cannabis) was analyzed for moisture content (using an Ohaus MB23), terpene preservation (using a 7820A/5977B gas chromatograph-mass spectrometry (GC-MS)), and microbial load. Of all samples analyzed, none fluctuated more than +/−1% in moisture content. In other words, no significant change in moisture content was observed between the pre-sterilization cannabis flower and the post-sterilization cannabis flower, for the same set of process/program parameters (recipe).

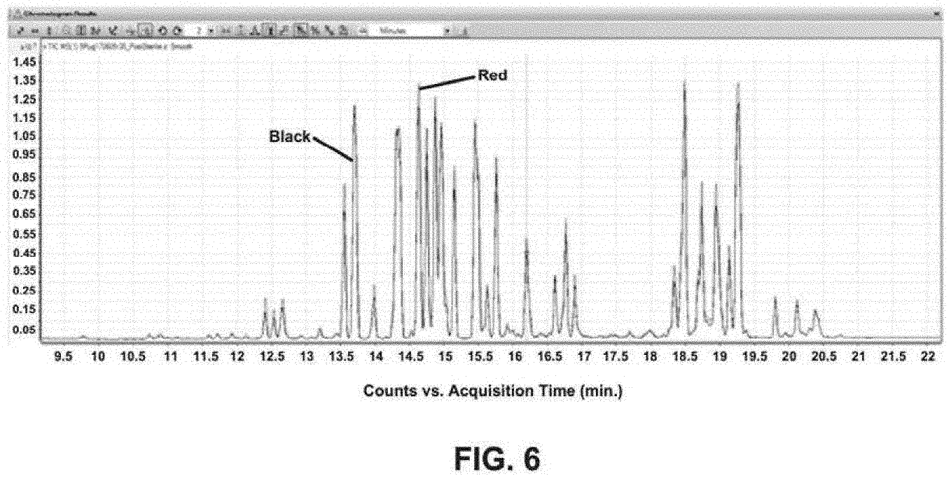

FIG. 6 shows an overlay of two chromatograms analyzing terpenes of the samples, with each peak corresponding to an individual terpene in the cannabis plant. The chromatogram labelled “red” is associated with the pre-sterilized cannabis flower, and the chromatogram labelled “black” is associated with the post-sterilized cannabis flower. As can be observed in FIG. 6, there is no significant change in terpene profile between the pre- and post-sterilization cannabis flower.

Six batches of cannabis (Sour Diesel strain) and seven batches of cannabis (OG Kush strain) were processed using an apparatus and method of the present disclosure, and the final sterilized product (the processed cannabis) was analyzed for microbial load. The microbial load testing was performed using a modified USP <61> and <62> method for determination of total yeast and molds (Saboraud dextrose agar), total aerobic bacteria (tryptic soy agar), Salmonella (xylose lysine deoxycholate agar), E. coli (MacConkey agar), and S. aureus (Mannitol salt agar). The results are shown in the following TABLE 4.

TABLE 4
Example Microbial Testing Data

| | | | Aerobic | Aerobic |
|---|---|---|---|---|
| | Mold, | Mold, | Bacteria, | Bacteria, |
| | Pre- | Post- | Pre- | Post- |
| STRAIN | Purification | Purification | Purification | Purification |
| Sour Diesel | 100,000 | 3,000 | 180,000 | 0 |
| Sour Diesel | 27,500 | 0 | 12,000 | 0 |
| Sour Diesel | 47,000 | 8,070 | 110,000 | 100 |
| Sour Diesel | 130,000 | 1,000 | 160,000 | 45 |
| Sour Diesel | 37,000 | 0 | 0 | 0 |
| Sour Diesel | 25,800 | 0 | 0 | 0 |
| OG Kush | 33,000 | 4,200 | 80,000 | 0 |
| OG Kush | 110,000 | 3,330 | 4,000 | 0 |
| OG Kush | 260,000 | 1,040 | 72,000 | 0 |
| OG Kush | 165,000 | 0 | 180,000 | 0 |
| OG Kush | 84,000 | 3,010 | 180,000 | 0 |
| OG Kush | 750,000 | 750 | 120,000 | 500 |
| OG Kush | 172,000 | 3,700 | 180,000 | 0 |

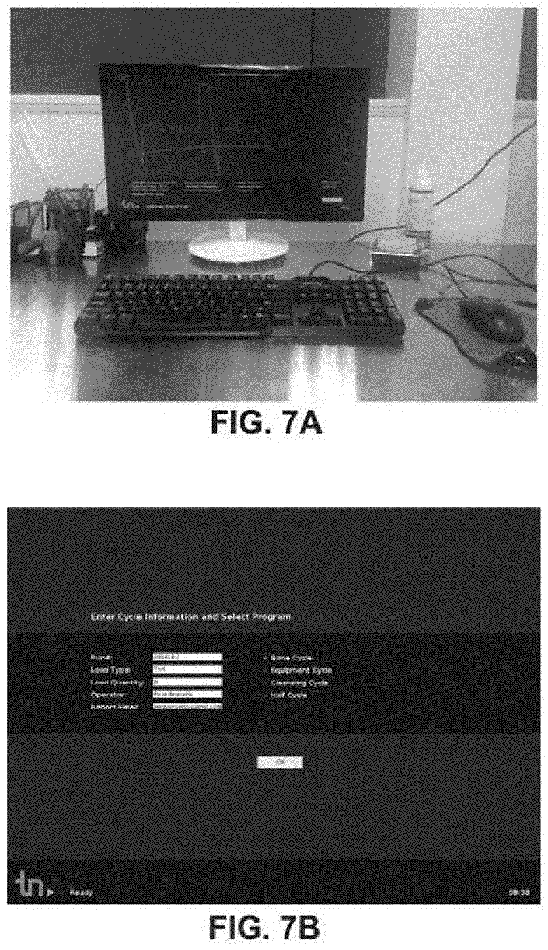

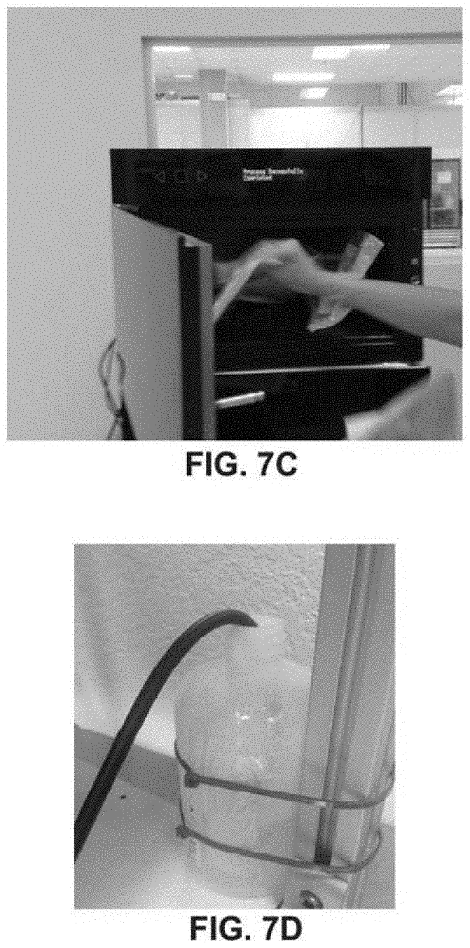

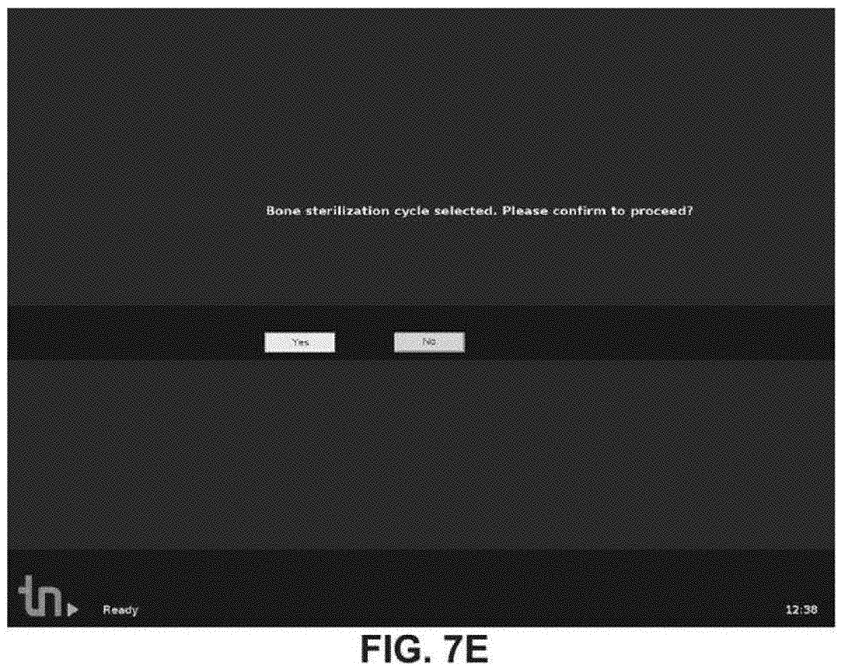

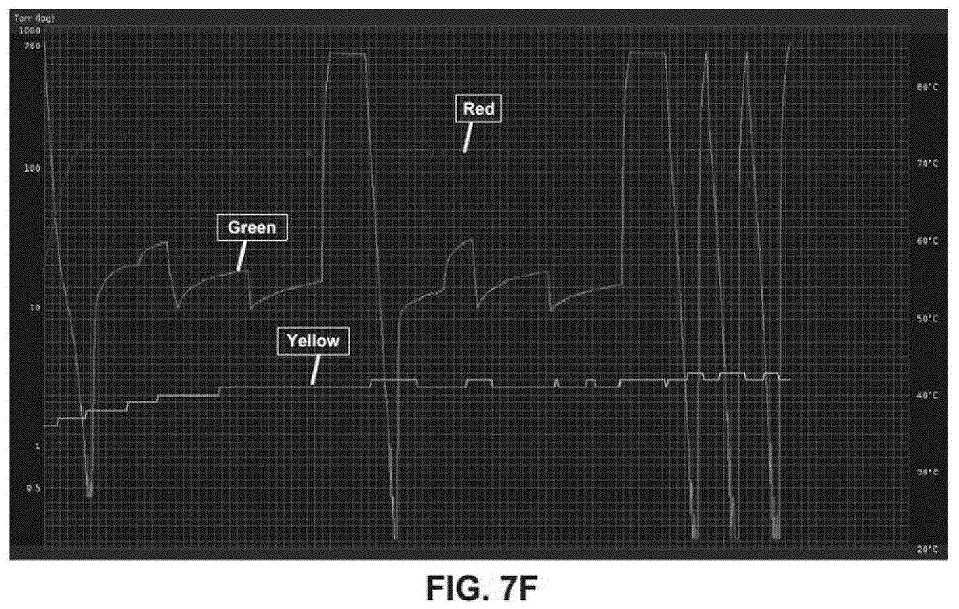

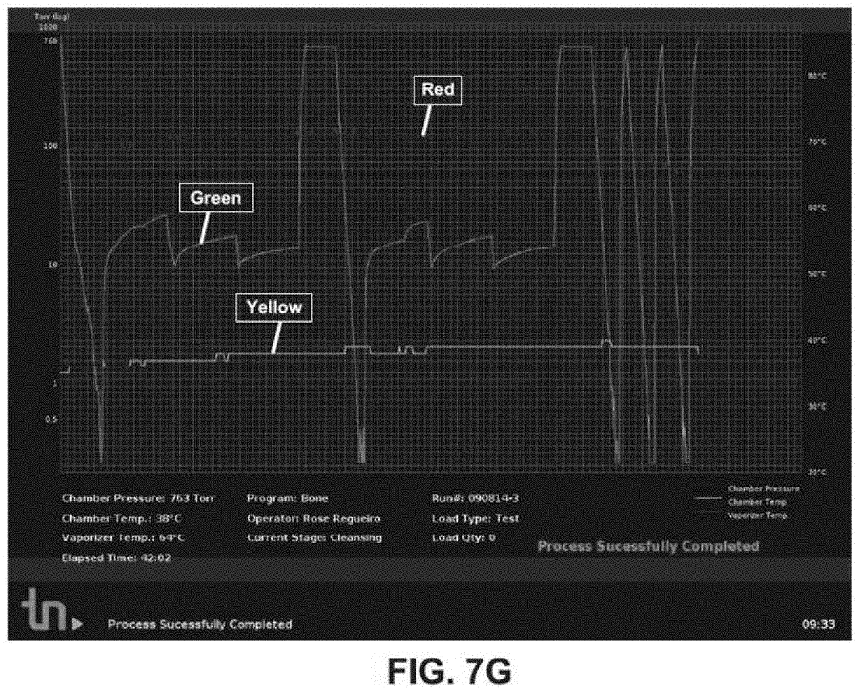

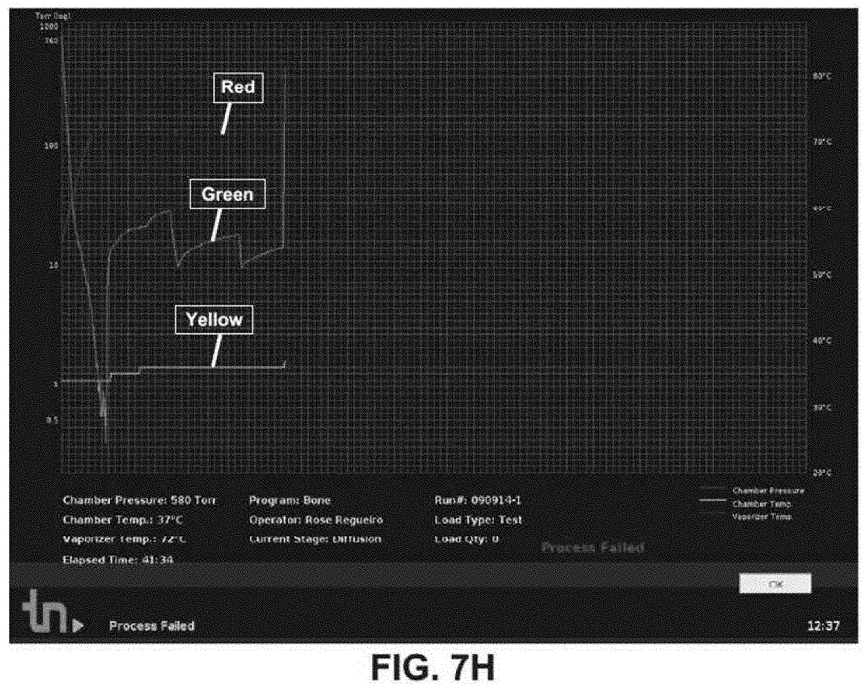

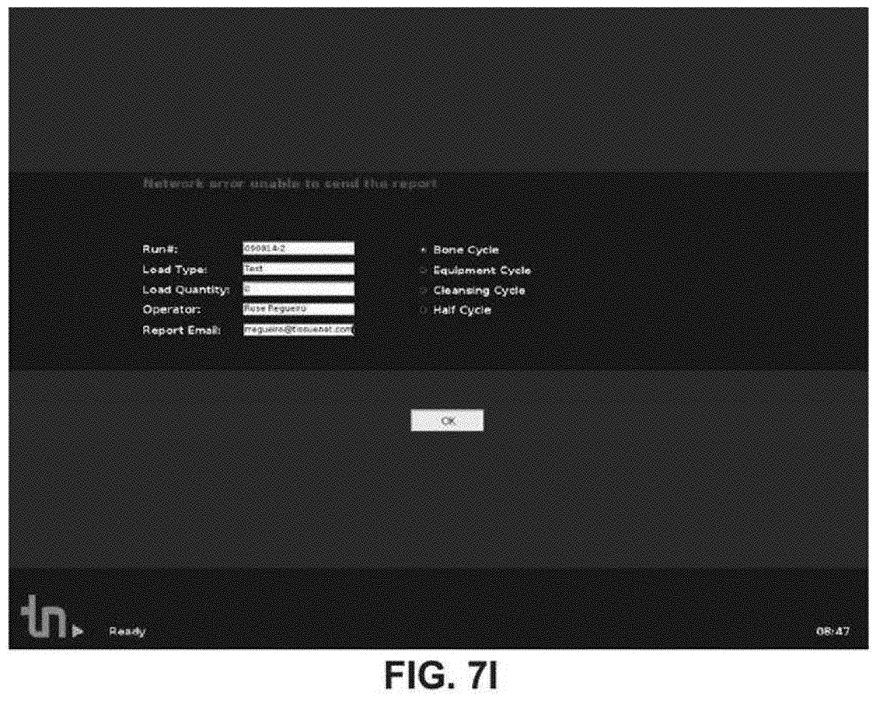

FIGS. 7A-7I show an illustrative implementation of a system for purifying, preserving, hydrating and/or infusing organic and biological material. The system comprises an apparatus having a user interface, menu and process screens, a vacuum chamber, and a reagent container. The system is configured to perform various functions including, but not limited to, (1) purification of pathogens (including, but not limited to, mold, yeast, bacteria, fungi, and/or viruses), (2) removal of non-pathogens, (3) rehydration of a material to restore or increase a moisture level thereof, and/or (4) infusion of one or more substances (including, but not limited to, terpenes, organic essential oils, and/or other liquids to enhance terpene profiles in dried cannabis flower).

The system includes stand-alone hardware that is operated in a closed environment, embedded software and accessories for using (1) reactive oxygen for purification of the material, (2) DI, IO or other types of water or solvent for rehydration of the material, and/or (3) one or more of a variety of cannabis/non-cannabis derived terpenes and organic (non-alcohol) essential oils and nutraceutical based products (e.g., for infusion). The foregoing materials (1)-(3) may collectively be referred to as “reagents.” The reagents can be further concentrated (as compared with a starting concentration thereof), vaporized and/or injected within the vacuum chamber in a factory validated closed-loop process referred to herein as a “cycle”. The cycle process(es) can inactivate microorganisms and rehydrate and/or infuse dried cannabis flower (or other plant or plant-derived material) while maintaining safe conditions. The cycle process(es) can be predefined/pre-programmed and controlled using a programmable logic controller (PLC) of the system. All interactions with the PLC and control over cycles can be performed using the HMI located on the face of the machine (shown, for example, in FIG. 7C and FIG. 4). Cycle and infusion efficacy can depend on processing time, temperature and/or pressure. Upon completion of a cycle process, remaining/residual/excess vapor can be removed from the cycle environment (e.g., the vacuum chamber) and safely decomposed to atmosphere by catalytic reactions.

System functions that are programmable and/or usable by an operator can be hosted inside the apparatus (e.g., stored within a memory that is operably coupled to a processor). The functions can be accessed by authorized representatives (e.g., in response to their entry, via the user interface, of authorized user credentials, and/or by the removal of an enclosure of the apparatus).

The apparatus includes an HMI with a color display. An operator can define, initiate and/or terminate processes using the HMI panel, for example, by inputting process selections. FIG. 7A shows an operator station or monitor. FIG. 7B shows an illustrative user interface with a main menu.

The vacuum chamber shown in FIG. 7C is constructed from aluminum for durability and ease of cleaning. An interior volume of the vacuum chamber can be accessed through the front door which is shown ajar in FIG. 7C. The vacuum chamber door is mounted on hinges, and can be held shut by magnets and/or other couplers (e.g., latches) when at atmospheric pressure and/or under vacuum during device operation.

The apparatus can include an onboard computing device having Wi-Fi connectivity capability. The wireless communication capability can facilitate communications between the apparatus and remote devices. The wireless communications can be performed for uploading and/or downloading of process records and software updates, remote diagnostics, and the emailing (or other transmission) of cycle/process records, for example, to a facility manager.

A complete run of the system can be referred to as a process cycle. Throughout a process cycle, the device achieves or satisfies predetermined parameters (e.g., pressure, flow rate and/or temperature set points). A set of cycle and safety parameters aggregated to form a process cycle are called a process cycle recipe. Different programs can be accessible via the HMI and selectable by the operator for the processing of a desired material.

A process cycle can include one or more of the following processes, in any combination and order:
Vacuum Pump & Leak Diagnostics: The device chamber is pumped to create a vacuum. Excess humidity is removed. Several automatic diagnostics of device components are performed.
Injection: Vaporized reagent is injected into the chamber in precisely controlled quantities.
Diffusion: The load (material) is exposed to the vaporized reagent. This step can be repeated (e.g., three times) during a single full cycle.
Cleansing: The cycle chamber and the cycle load within are cleansed to remove residual reagents.

During operation, the apparatus consumes a reactive oxygen solution as shown in FIG. 7D. The cycle reagent can be positioned within the apparatus enclosure, affixed to an exterior of the enclosure or exterior to the apparatus. Replacement of the cycle reagent can include the following steps (by way of example only).
Step 1: Open the right side door of the apparatus or observe an exterior right-hand side of the apparatus.
Step 2: Depress the stainless steel reagent connection button located on the reagent connection valve.
Step 3: Remove the existing reagent.
Step 4: Ensure that the replacement reagent is within the expiration period and meets all specifications.
Step 5: Remove the container cap with drip and connection tubing for reuse with the new container.
Step 6: Firmly pressing a male side of a reagent connection tubing into a female tubing receptacle until a click sound is produced.
Step 5: Record the date on which the reagent was opened and the initials of the operator.
Step 6: Press start so that the device will automatically prime reagent for use.

In some scenarios, the cycle load/material and/or packaging thereof does not contain any hygroscopic materials or materials made from cellulose. Alternatively or in addition, the cycle load/material is not wet, nor does it contain liquids.

In those or other scenarios, a cannabis flower load is dried and packaged, being dry and free of foreign objects or non-approved packaging, prior to being processed by the system. A prepared load may allow for sufficient clearance/space for air to circulate, during the reagent diffusion process, without overcrowding the chamber within. For example, the vacuum chamber may be filled with a load/material to any degree up to but not exceeding 85% of capacity.

In those or other scenarios, the packaging is breathable and/or does not contain hygroscopic materials such as cellulose. For example, the packaging material can include a mesh, Tyvek®, and/or a polyethylene packaging material.

During use, the vacuum chamber may be loaded in such a manner that the cycle reagent can circulate freely therewithin and readily diffuse into the packaging. For example, the load may be evenly/uniformly distributed within the vacuum chamber, and/or multiple discrete pouches of the load may be positioned within the vacuum chamber without being overly packed. Void space may be reserved within the vacuum chamber to allow for proper vapor circulation. Once the system has been loaded, the cycle program menu can load on the HMI screen. An operator may then select a desired cycle program or recipe (e.g., from an assortment of pre-programmed recipes). Following program selection, a confirmation screen appears in the HMI, and the operator can verify the selected program. Upon selection of the program, a “start cycle” button will appear in the HMI with which the operator can start the desired cycle.

A purify or purification process can target pathogens for vaporized disinfection. Suitable loads/materials include, for example, products packaged in Tyvek packaging or a mesh bag made from nylon, with no metal zippers or metal material.

An infuse cleansing cycle can be performed after a completed run or after a failed run (e.g., after a power outage, vacuum failure, etc.) to ensure that the chamber and its contents are not flooded with reactive oxygen.

During operation, a cycle progress screen will appear after a brief warm-up period. Cycle process steps and other important cycle details are listed on the screen. Through the HMI interface, the operator can observe all individual steps of the cycle process and related parameters as they occur, for example in the form of real-time graphics. Real time process graphics show graphs of chamber pressure, chamber temperature and vaporizer temperature over time as associated with the various stages of the cycle process.

As shown in FIG. 7F, a cycle process begins with evacuation of the vacuum chamber. This is illustrated by a pressure line (labelled “green”) which slopes downward from the top of the graph toward the bottom. Following evacuation, injection occurs. Accordingly, the pressure line rises. Injection is followed by three pulsed diffusion processes. This causes the pressure line to have 3 valleys and 2 additional hills. The chamber pressure is then increased to a process high, which causes a steep rise in the pressure line. The curve shape for the first half cycle is repeated for the second half cycle. The vaporizer temperature line (labelled “red”) tracks chamber pressure on a considerably narrower scale. Typically, the vaporizer temperature falls during chamber evacuation and rises again with pressurization of the chamber. The chamber temperature line (labelled “yellow”) also tracks chamber pressure, but within a considerably narrower band (i.e., almost steady).

A running cycle process can be aborted by an abort button located at the lower right side of the screen (with optional subsequent verification by the operator via the HMI). When a cycle process has been aborted, the apparatus can immediately initiate the removal and completion stages (e.g., including a cleansing step, ensuring safe handling of the cycle load). As such, even after aborting the process cycle, the apparatus can remain operational to complete the cleansing phase of the cycle process. When the apparatus stops running the cycle process, a message can appear on the HMI screen to indicate a complete cycle process or an incomplete cycle process.

Upon successful completion of a validated cycle process, a green colored completion message can appear (see FIG. 7G) indicating that the cycle process has been successfully completed. The operator is then invited (e.g., via an HMI message) to open the cycle chamber door and unload the sterile load.

In the event of an unsuccessful (or failed) cycle process, a red colored incomplete message can appear (see FIG. 7H) in the HMI display indicating that the cycle was not successful and that the cycle load is not sterile.

Upon successful or failed completion of the cycle process, a cycle report can be compiled and, optionally, sent over a communications network (e.g., to a mobile or other type of remote compute device). Should the apparatus experience difficulty in connecting to the network, a network connection error can be generated in the HMI display (see FIG. 7I). However, even if the network sending of the report fails, the report can be retained/stored in the apparatus memory (or a memory that is otherwise in communication therewith) for future access.

In some scenarios, the apparatus can maintain backups of sterilizer and cycle related data (e.g., for documentation purposes). The report files can be automatically generated, and can be emailed to a preset email account. An illustrative successfully completed cycle report is shown below.

[symbol]

Cycle Report [symbol] 08:50
Program: Bone
Run # [symbol]
Load Type: Test
Load Quantity: 0
Operator: Rose [symbol]
Device Num #: 104
00:00 Started initialization >>
00:00 Injection check [symbol] >>
00:00 Started Vacuum Pumping >>
00:02 Door Test in 2 sec. >>
01:12 Seal Test in [symbol] sec. >>
02:10 Humidity Test in [symbol] sec. >>
02:40 Started Injection >>
02:47 Pressure prior to 1st injection Torr >>
03:24 Pressure Rise after 1st injection 11 Torr >>
0 [symbol] :23 Pressure prior to 2nd injection [symbol] Torr >>
06:00 Pressure Rise after 2nd injection 2 Torr >>
07:01 Started Diffusion >>
07:01 Pre-Separation Pressure 24 Torr >>
07:33 Separation Pump in 01 sec. >>
11:41 Separation Pump in 7 sec. >>
18:07 Completed 1st Half in [symbol] sec. >>
18:07 Started Pumping >>
19:27 Residue Test in 60 sec. >>
19: [symbol] 7 Started injection >>
19:58 Pressure prior to 1st injection 0 Torr >>
20: [symbol] Pressure Rise after 1st injection 11 Torr >>
22:35 Pressure prior to 2nd injection 1 [symbol] Torr >>
23:12 Pressure Rise after 2nd injection 4 Torr >>
24:12 Started Diffusion >>
24:12 Pre-Separation Pressure 21 Torr >>
24:25 Separation Pump in 18 sec. >> [symbol]
:33 Separation Pump in 7 sec. >> [symbol]
:00 Completed 2nd Half in 26 sec. >> [symbol]
:00 Started Cleansing >>
36:15 1st Cleansing Pump in 75 sec. >>
37:18 1st Cleansing Vent in 27 sec. >>
38:31 2nd Cleansing Pump in 72 sec. >>
39:35 2nd Cleansing Vent in 27 sec. >>
40:49 3rd Cleansing Pump in 73 sec. >>
41:52 3rd Cleansing Vent in 27 sec. >>
42:02 Completing Cycle in 0 Sec. >>
42:02 Process Successfully Completed >>

[symbol]

indicates data missing or illegible when filed

A cycle report can include timestamps, information for associated critical events and parameters throughout the cycle process. When a critical event and/or parameter was successfully completed/passed, it is marked with a pass (>>) sign. When such an event or parameter fails, it is marked “FAIL”. An illustrative failed cycle report is shown below. Failed events can be used, for example, for the diagnosis of the failed process cycles.

Icetech Cycle Report Sep. 8, 2014 08:50
Program: Bone
Run #: 090814-3
Load Type: Test
Load Quantity: 0
Operator: Rose Regueiro
Device Num #: 104
00:00 Started initialization >>
00:00 Injection check 230 >>
00:00 Started Vacuum Pumping >>
00:02 Door Test in 2 sec. >>
01:12 Seal Test in 64 sec. >>
02:10 Humidity Test in 64 sec. >>
02:40 Started Injection >>
02:47 Pressure prior to 1st injection 0 Torr >>
03:24 Pressure Rise after 1st injection 11 Torr >>
05:23 Pressure prior to 2nd injection 19 Torr >>
06:00 Pressure Rise after 2nd injection 2 Torr >>
07:01 Started Diffusion >>
07:01 Pre-Separation Pressure 24 Torr >>
07:33 Separation Pump in 31 sec. >>
11:41 Separation Pump in 7 sec. >>
16:07 Completed 1st Half in 28 sec. >>
18:07 Started Pumping >>
18:27 Residue Test failed after 120 sec. >FAIL
19:28 Process Failed

As evident from the forgoing discussion, the present solution concerns implementing systems and methods for processing a product. In some scenarios, the methods comprise: heating a vacuum chamber to a first predetermined temperature; providing an organic plant material within the vacuum chamber (where the organic material may have a moisture content of from about 1% to about 40%); heating a vaporizer to a second predetermined temperature (where the vaporizer is in fluid communication with the vacuum chamber); performing operations by a vacuum pump to evacuate the vacuum chamber to a first predetermined, sub-atmospheric pressure; injecting a liquid reagent into the vaporizer such that the liquid reagent transforms into a gaseous/aerosolized reagent; introducing the gaseous/aerosolized reagent into the vacuum chamber; waiting a predetermined duration so as to achieve a sterilization of the organic plant material; performing a first venting of the vacuum chamber to atmospheric pressure; performing operation by the vacuum pump to evacuate the vacuum chamber to a second predetermined, subatmospheric pressure so as to remove a reagent residue from the organic plant material; and performing a second venting of the vacuum chamber to atmospheric pressure. In some implementations, the methods may further comprises: performing operations by the vacuum pump to evacuate the vacuum chamber to a second predetermined, sub-atmospheric pressure so as to remove a reagent residue; and performing a third venting of the vacuum chamber to atmospheric pressure. The sterilization may comprise or result in at least a 50% bioburden reduction (reduction of harmful microbes such as mold, bacteria, fungus, etc.), at least a 60% bioburden reduction, at least a 70% bioburden reduction, at least a 80% bioburden reduction, at least a 90% bioburden reduction, at least a 95% bioburden reduction, at least a 97% bioburden reduction, at least a 98% bioburden reduction, at least a 99% bioburden reduction, at least a 99.5% bioburden reduction, and/or at least a 99.9% bioburden reduction. In some embodiments, a mold count is reduced to less than 50,000 CFU, less than 25,000 CFU, less than 10,000 CFU, less than 5,000 CFU, less than 1,000 CFU, less than 500 CFU, less than 100 CFU, less than 50 CFU, and/or less than 10 CFU.

In those or other scenarios, the methods comprise: heating a vacuum chamber to a first predetermined temperature; providing an organic plant material within the vacuum chamber (where the organic plant material has a moisture content of from about 0% to about 40%); heating a vaporizer to a second predetermined temperature (where the vaporizer is in fluid communication with the vacuum chamber); performing operations by a vacuum pump to evacuate the vacuum chamber to a first predetermined, sub-atmospheric pressure; injecting a liquid supplement into the vaporizer such that the liquid supplement transforms into a gaseous/aerosolized supplement; introducing the gaseous/aerosolized supplement into the vacuum chamber; and waiting a predetermined duration so as to achieve a infusion and/or saturation of the organic plant material with the supplement. The supplement can include, but is not limited to, a cannabinoid oil, a terpene, a terpinoid, a flavonoid, a cannaflavin, THC and/or CBD. The organic plant material can include, but is not limited to, a cannabis plant material (e.g., a raw cannabis plant material, a dried cannabis plant material and/or a cannabis flower).

In those or other scenarios, the methods are performed to reduce the bioburden of cannabis material and infuse the cannabis material with natural cannabis extracts to provide a sanitized organic cannabis product. Accordingly, the methods comprise: obtaining organic cannabis material; processing the organic cannabis material such that the organic cannabis material has a moisture level between about 10% and about 16%; heating a pressure chamber to a first predetermined temperature via a first heater; inserting the organic cannabis material into the pressure chamber; heating a vaporizer via a second heater to a second predetermined temperature (where the vaporizer is in fluid communication with the pressure chamber); performing a first pressure change of the pressure chamber to a first predetermined pressure (where the first predetermined pressure is a sub-atmospheric pressure); introducing a purifying, oxygen-based reagent into the pressure chamber via the heated vaporizer such that the purifying, oxygen-based reagent is in at least one of an aerosol, vapor, and/or gas form; processing the organic cannabis material in the pressure chamber with the purifying, oxygen-based reagent for at least one cycle having a predetermined duration (where the processing reduces the bioburden of the organic cannabis material without irradiation); performing a first venting of the pressure chamber (where the first venting raises the pressure of the pressure chamber to atmospheric pressure); performing at least one second pressure change of the pressure chamber to a second predetermined pressure to remove residue of the purifying, oxygen-based reagent from the organic cannabis material (where the second predetermined pressure is a sub-atmospheric pressure); performing a second venting of the pressure chamber (where the second venting raises the pressure of the pressure chamber to atmospheric pressure); heating the pressure chamber to a third predetermined temperature via the first heater; heating the vaporizer to a fourth predetermined temperature via the second heater; performing at least one third pressure change of the pressure chamber to a third predetermined pressure (where the third predetermined pressure is a sub-atmospheric pressure); introducing a supplement into the pressure chamber via the vaporizer (where the supplement is one or more natural cannabis extracts or components thereof); processing the organic cannabis material with the supplement in the pressure chamber for at least one infusion cycle having a duration such that the organic cannabis material is infused with the one or more natural cannabis extracts or components thereof to produce a sanitized organic cannabis product; and outputting the sanitized organic cannabis product from the pressure chamber.

Post-Preservation Processing of A Sterilized Product

In some scenarios discussed above, the sanitized product output from the above vacuum induced purification and sterilization system is additionally quantitatively tested and packaged for preservation thereof. This packaging is designed to establish a safe and extended shelf-life of the sanitized product. The packaging can be achieved in accordance with Modified Atmospheric Package (MAP) technology.

Referring now to FIG. 8, there is provided a flow diagram of an illustrative method 800 for post-preservation processing of a sterilized biological product. Method 800 begins with 802 and continues with 804 where a sterilized biological product is obtained. The sterilized biological product can include, but is not limited to, sage, rosemary, parsley, basil, catnip and/or cannabis (i.e., hemp and marijuana). The sterilized biological product may be in a pre-packaged form, i.e., still reside in package 112 shown in FIG. 1. In this case, N pre-packaged sterilized biological products are obtained in 804, where N in an integer equal to or greater than one.

Next in 806, a given sterilized biological product is tested for a pathogenetic quantitative state. This testing can include, but is not limited to, analyzing the given sterilized biological product (e.g., processed cannabis) for a microbial load. The microbial load testing may be performed using a modified USP <61> and <62> method for determination of a total amount of yeast in the product, an existence of any molds in/on the product (e.g., Saboraud dextrose agar), a total amount of aerobic bacteria in/on the product (e.g., tryptic soy agar), the existence of Salmonella in/on the product (e.g., xylose lysine deoxycholate agar), the existence of E. coli (e.g., MacConkey agar) in/on the product, and/or the existence of S. aureus (e.g., Mannitol salt agar) in/on the product.

In 808, a determination is made as to whether the pathogenetic quantitative state is acceptable. This determination can involve comparing at least one measured value to a threshold value. For example, if a measured amount of yeast exceeds a first given regulatory level and/or a measured amount of aerobic bacteria exceeds a second regulatory level, then a determination is made that the pathogenetic quantitative state of the sterilized biological product is not acceptable. In contrast, if the measured amount of yeast is less than the first given regulatory level and/or a measured amount of aerobic bacteria is less than the second regulatory level, then a determination is made that the pathogenetic quantitative state of the sterilized biological product is acceptable. The determination may also be based on whether or not the testing found the existence of mold, Salmonella, E. coli and/or S. aureus in/on the product. The pathogenetic quantitative state of the sterilized biological product is determined to be acceptable when no mold, Salmonella, E. coli and/or S. aureus was detected in/on the product. In contrast, the pathogenetic quantitative state of the sterilized biological product is determined to be unacceptable when the existence of mold, Salmonella, E. coli and/or S. aureus was detected in/on the product.

If the pathogenetic quantitative state of the sterilized biological product is determined to be unacceptable [808:NO], then method 800 may return to 806 to re-test the given sterilized biological product or perform another iteration of the testing using a next sterilized biological product that was obtained in 804. Additionally or alternatively, the given sterilized biological product is discarded.

If the pathogenetic quantitative state of the given sterilized biological product is determined to be acceptable [808:YES], then method 800 may continue with optional operations 810-812. 810-812 involve: optionally returning to 802 so that a pathogenetic quantitative state of all N sterilized biological products is analyzed; and optionally arranging the N sterilized biological products in a stacked arrangement.

In 814, the sterilized biological product(s) is(are) packaged using MAP technology. The result of this MAP based packaging is referred to herein as a MAP sterilized biological product. The MAP based packaging can be achieved using a package with an inert gas. The inert gas can include, but is not limited to, argon or nitrogen. The MAP based packaging involves either actively or passively controlling or modifying an atmosphere surrounding the sterilized biological product(s) within a package. The package can be made of one or more different types of materials and/or films. The MAP based packaging can be achieved using an automatic MAP/gas flush heat seal machine. Such automatic MAP/gas flush heat seal machines are well known in the art. The modified atmosphere can be created by altering a natural distribution and makeup of atmospheric gases. When applied to packaging, this involves modifying or controlling the makeup of gases contained within the package to provide optimal conditions for increasing the shelf life, reducing oxidization of the sterilized biological product, and/or reducing spoilage of the sterilized biological product.

There are two different kinds of modified atmosphere packaging: passive and active. An active modified atmosphere packaging is a packaging in which gases therein have been displaced/flushed and replaced with another gas(es). A passive modified atmosphere packaging is a packaging in which a desired atmosphere therein develops naturally as a consequence of the sterilized biological product's respiration and the diffusion of gas(es) through the packaging material. In the active modified atmosphere packaging scenarios, an inert gas is pumped into the packaging before sealing of the same for displacing ambient oxygen therein. This results in a decrease in an amount of oxygen inside the sealed package, which in turn provides a decreased rate of pathogenic growth.

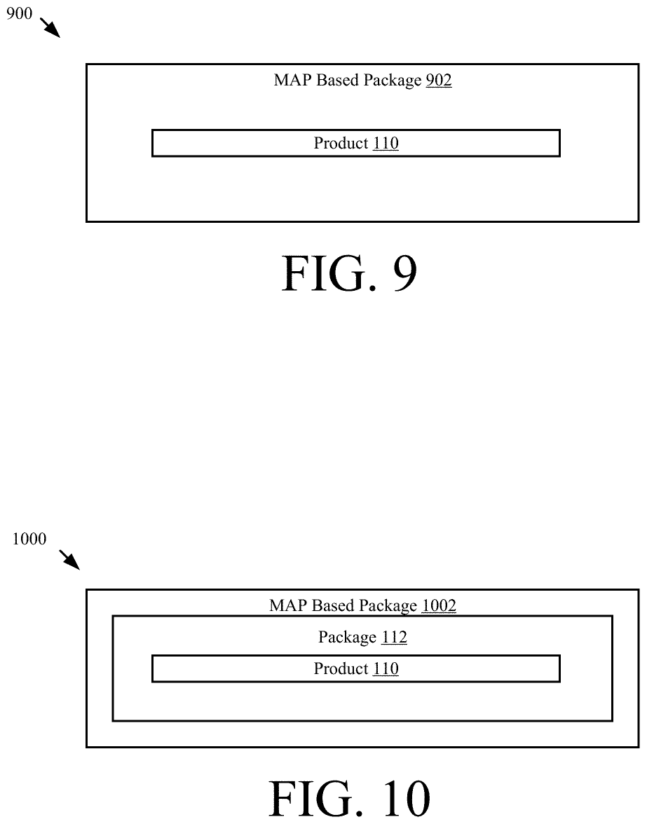

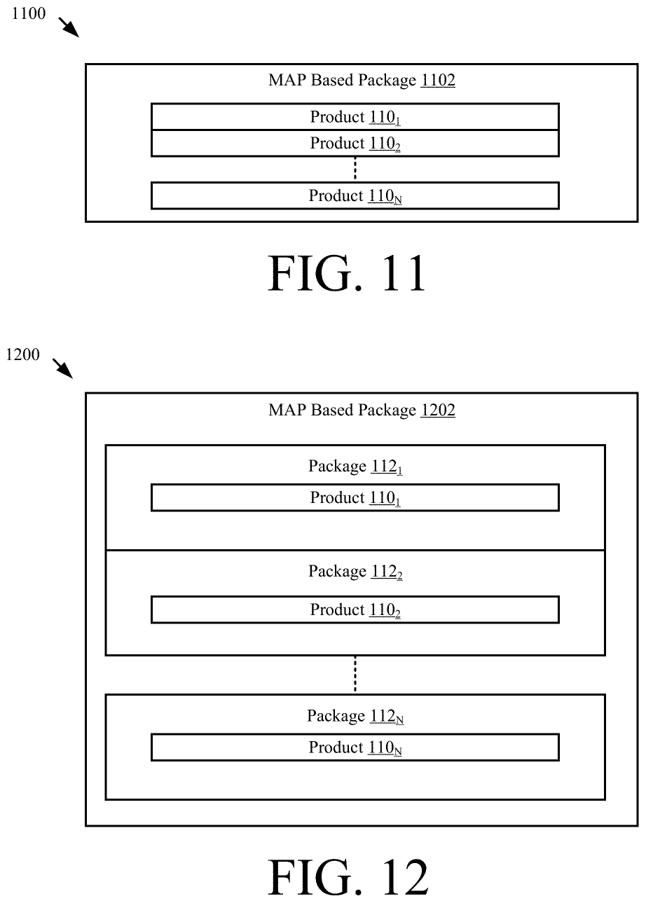

Illustrative MAP sterilized biological products are shown in FIGS. 9-12. The MAP sterilized biological product 900 of FIG. 9 comprises a product 110 packaged in a MAP based package 902. The MAP sterilized biological product 1000 of FIG. 10 comprises a product 110 packaged in both package 112 and a MAP based package 1002. The MAP sterilized biological product 1100 of FIG. 11 comprises a plurality of stacked products 110₁, 110₂, . . . , 110_{N} packaged in a MAP based package 1102. The MAP sterilized biological product 1200 of FIG. 12 comprises a plurality of stacked products 110₁, 110₂, . . . , 110_{N} that are respectively packaged in packages 112₁, 112₂, . . . , 112_{N}. The stacked pre-packaged products 110₁/112₁, 110₂/112₂, . . . , 110_{N}/112_{N} are encompassed by a MAP based package 1102.

Referring again to FIG. 8, method 800 continues with 816 where the MAP sterilized biological product is tested for suspended animation. The term “suspended animation” as used here refers to a lack of oxygen or an acceptable amount of oxygen (i.e., an amount of oxygen that is equal to or less than a pre-defined threshold amount). This testing is achieved using a commercially available headspace gas analyzer for MAP technology. The headspace gas analyzer ensures that the residual oxygen in the MAP sterilized biological product complies with a pre-defined limit. If the amount of residual oxygen exceeds the pre-defined limit, then a determination is made in 816 that the level of suspended animation is unacceptable. In this case [818:NO], method 800 returns to 804 so that the MAP sterilized biological product may be re-tested and/or re-packaged via MAP technology, as shown by 820. If the amount of residual oxygen is equal to or does not exceed the pre-defined limit, then a determination is made in 818 that the level of suspended animation is acceptable. In this case [818:YES], method 800 ends or other operations are performed as shown by 822.

The other operations can include, but are not limited to, returning to 802, and/or delivering the MAP sterilized biological product to an entity (e.g., a wholesaler) or individual (e.g., consumer). The benefit of method 800 is that the MAP sterilized biological product will remain in its tested pathogenetic and purified state while the MAP based packaging thereof remains sealed.

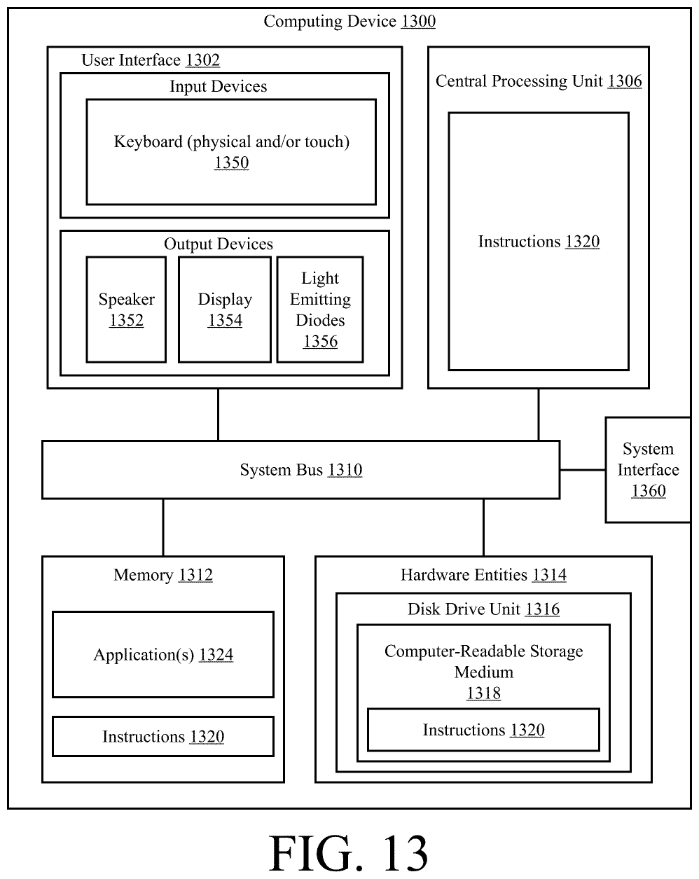

Referring now to FIG. 13, there is provided an illustration of an illustrative architecture for a computing device 1300. The controller 140 of FIG. 1 is at least partially the same as or similar to computing device 1300. As such, the discussion of computing device 1300 is sufficient for understanding the controller 140 of FIG. 1.

Computing device 1300 may include more or less components than those shown in FIG. 13. However, the components shown are sufficient to disclose an illustrative solution implementing the present solution. The hardware architecture of FIG. 13 represents one implementation of a representative computing device configured to operate a vehicle, as described herein. As such, the computing device 1300 of FIG. 13 implements at least a portion of the method(s) described herein.

Some or all components of the computing device 1300 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 13, the computing device 1300 comprises a user interface 1302, a Central Processing Unit (CPU) 1306, a system bus 1310, a memory 1312 connected to and accessible by other portions of computing device 1300 through system bus 1310, a system interface 1360, and hardware entities 1314 connected to system bus 310. The user interface can include input devices and output devices, which facilitate user-software interactions for controlling operations of the computing device 1300. The input devices include, but are not limited to, a physical and/or touch keyboard 1350. The input devices can be connected to the computing device 1300 via a wired or wireless connection (e.g., a Bluetooth® connection). The output devices include, but are not limited to, a speaker 1352, a display 1354, and/or light emitting diodes 1356. System interface 1360 is configured to facilitate wired or wireless communications to and from external devices (e.g., network nodes such as access points, etc.).

At least some of the hardware entities 1314 perform actions involving access to and use of memory 1312, which can be a Random Access Memory (RAM), a disk drive, flash memory, a Compact Disc Read Only Memory (CD-ROM) and/or another hardware device that is capable of storing instructions and data. Hardware entities 1314 can include a disk drive unit 1316 comprising a computer-readable storage medium 1318 on which is stored one or more sets of instructions 1320 (e.g., software code) configured to implement one or more of the methodologies, procedures, or functions described herein. The instructions 1320 can also reside, completely or at least partially, within the memory 1312 and/or within the CPU 1306 during execution thereof by the computing device 1300. The memory 1312 and the CPU 1306 also can constitute machine-readable media. The term “machine-readable media”, as used here, refers to a single medium or multiple media (e.g., a centralized or distributed database, and/or associated caches and servers) that store the one or more sets of instructions 1320. The term “machine-readable media”, as used here, also refers to any medium that is capable of storing, encoding or carrying a set of instructions 1320 for execution by the computing device 1300 and that cause the computing device 1300 to perform any one or more of the methodologies of the present disclosure.

All combinations of the foregoing concepts and additional concepts illustrated (provided such concepts are not mutually inconsistent) are contemplated as being part of the disclosure. The terminology explicitly employed herein that also may appear in any disclosure incorporated by reference should be accorded a meaning most consistent with the particular concepts disclosed herein.

The drawings are primarily for illustrative purposes and are not intended to limit the scope of the disclosure. The drawings are not necessarily to scale; in some instances, various aspects of the disclosure may be shown exaggerated or enlarged in the drawings to facilitate an understanding of different features.

In order to address various issues and advance the art, the entirety of this application (including any Cover Page, Title, Headings, Background, Summary, Brief Description of the Drawings, Detailed Description, Embodiments, Numbered Embodiments, Abstract, Figures, Appendices, and otherwise) shows, by way of illustration, various embodiments in which the disclosed innovations can be practiced. The advantages and features of the application are of a representative sample of embodiments only, and are not exhaustive and/or exclusive. They are presented to assist in understanding and teach the disclosed principles.

It should be understood that the examples and embodiments are not representative of all innovations within the scope of the disclosure. As such, certain aspects of the disclosure have not been detailed herein. That alternate embodiments may not have been presented for a specific portion of the innovations or that further undescribed alternate embodiments may be available for a portion is not to be considered a disclaimer of those alternate embodiments. It will be appreciated that many of those embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

Various inventive concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, and may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently set forth in specific embodiments. Applicant reserves all rights in those innovations including the right to claim such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or examples on equivalents to the embodiments. Depending on the particular desires and/or characteristics of an implementation, various embodiments of the technology disclosed herein may be implemented in a manner that enables a great deal of flexibility and customization as described herein. Patents, patent applications, patent application publications, journal articles and protocols referenced herein are incorporated by reference in their entireties, for all purposes.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in claims, shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, the terms “herb”, “herbs” and “herbal” all refer to an annual, biennial, or perennial plant that does not develop persistent woody tissue but dies down at the end of a growing season. Herbal plants typically are capable of flowering and producing seeds. In some contexts, the terms refer to a plant or plant part valued for its medicinal, savory, or aromatic qualities. Examples of herbs include, but are not limited to, sage, rosemary, parsley, basil, catnip and cannabis (i.e., hemp and marijuana).

As used herein, the terms “herbal composition” or “herbal product” refer to herbs, herbal materials, herbal preparations, and finished herbal products that contain parts of plants, other plant materials, or combinations thereof as active ingredients, including for use as a medicinal, food supplement, food additive, or the like. Herbs include crude plant material, for example, leaves, flowers, fruit, seed, and stems. Herbal materials include, in addition to herbs, fresh juices, gums, fixed oils, essential oils, resins, and dry powders of herbs. Herbal preparations are the basis for finished herbal products and may include comminuted or powdered herbal materials, or extracts, tinctures, and fatty oils of herbal materials. Finished herbal products consist of herbal preparations made from one or more herbs. See, e.g., Perspectives in Clinical Research, April-June 2016, 7(2):59-61.

As used herein, “spice” or “spices” refer to an aromatic or pungent plant (e.g., an herbal or vegetable substance) used as a flavoring and/or to flavor food, e.g., cloves, pepper, or mace. A spice comprises a whole plant or a part of a plant, and/or a powder made from that whole plant or plant part.

All transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

We claim:

1. A method for processing a product, comprising:
receiving the product in a vacuum chamber, the product enclosed within a first packaging item having at least a portion that is semi-permeable under vacuum conditions;
introducing a reagent into the vacuum chamber, the reagent comprising a combination of a sterilization substance for sterilizing the product and a preservation substance for preserving a sterilization state of the product;
causing the reagent to pass through the portion of the first packaging item that is semi-permeable such that a sterilization of the product by the sterilization substance occurs concurrently with a modification of an internal atmospheric condition within the first packaging item by the preservation substance; and
preserving the sterilized state of the product via the modified internal atmospheric condition of the first packaging.

2. The method according to claim 1, wherein the product is an organic material, a cellular material or a biological material.

3. The method according to claim 1, wherein the sterilization substance comprises at least one of hydrogen and oxygen.

4. The method according to claim 1, wherein the preservation substance comprises at least one of argon and nitrogen.

5. The method according to claim 1, further comprising emitting UV light within the vacuum chamber to further sterilize the product.

6. The method according to claim 1, further comprising:
introducing a supplement substance into the vacuum chamber;
causing the supplement substance to pass through the portion of the first packaging item that is semi-permeable and penetrate into the product.

7. The method according to claim 6, wherein the supplement substance comprises at least one of an essential oil and an extract.

8. The method according to claim 1, further comprising testing an oxygen level of the product after said preserving.

9. The method according to claim 1, further comprising testing a pathogenetic quantitative state of the product subsequent to said preserving.

10. The method according to claim 9, further comprising enclosing the product in a second packaging item using modified atmospheric package technology, when the results of said testing indicate that the pathogenetic quantitative state of the product is acceptable.

11. The method according to claim 10, further comprising testing an oxygen level of the product after being enclosed within the second packaging item.

12. A system, comprising:
a vacuum chamber configured to receive a product that is enclosed within a first packaging item having at least a portion that is semi-permeable under vacuum conditions;
a vaporizer configured to introduce a reagent into the vacuum chamber, the reagent comprising a combination of a sterilization substance for sterilizing the product and a preservation substance for preserving a sterilization state of the product; and
a controller configured to control operations of the vacuum chamber to cause the reagent to pass through the portion of the first packaging item that is semi-permeable such that a sterilization of the product by the sterilization substance occurs concurrently with a modification of an internal atmospheric condition within the first packaging item by the preservation substance;
wherein a preservation of the sterilized state of the product is facilitated by the modified internal atmospheric condition of the first packaging.

13. The system according to claim 12, wherein the product is an organic material, a cellular material or a biological material.

14. The system according to claim 12, wherein the sterilization substance comprises at least one of hydrogen and oxygen.

15. The system according to claim 12, wherein the preservation substance comprises at least one of argon and nitrogen.

16. The system according to claim 12, further comprising a device for emitting UV light within the vacuum chamber to facilitate further sterilization of the product.

17. The system according to claim 12, wherein
the vaporizer is further configured to introduce a supplement substance into the vacuum chamber; and
the controller is further configured to control operations of the vacuum chamber to cause the supplement substance to pass through the portion of the first packaging item that is semi-permeable and penetrate into the product.

18. The system according to claim 17, wherein the supplement substance comprises at least one of an essential oil and an extract.

19. The system according to claim 12, further comprising a tester configured to test an oxygen level of the product after the sterilized state of the product has been preserved.

20. The system according to claim 12, further comprising a tester configured to test a pathogenetic quantitative state of the product subsequent to the preservation of the sterilized state of the product.

21. The system according to claim 20, further comprising equipment configured to enclose the product in a second packaging item using modified atmospheric package technology, when the tester indicates that the pathogenetic quantitative state of the product is acceptable.

22. The system according to claim 21, wherein the tester is further configured to test an oxygen level of the product after being enclosed within the second packaging item.
